(19) United States
(12) Patent Application Publication
(10) Pub. No.: US 2024/0385860 A1
(43) Pub. Date: Nov. 21, 2024

(54) METHOD, DEVICE, AND STORAGE MEDIUM FOR INFORMATION INTERACTION

(71) Applicants: Beijing Zitiao Network Technology Co., Ltd., Beijing (CN); Lemon Inc., Grand Cayman (KY)

(72) Inventors: Yiguo WANG, Beijing (CN); Yang LIU, Beijing (CN); Bowen ZHAO, Beijing (CN); Yingdi SUN, Beijing (CN); Yibing ZHU, Los Angeles, CA (US)

(21) Appl. No.: 18/786,237

(22) Filed: Jul. 26, 2024

(30) Foreign Application Priority Data
Jul. 28, 2023 (CN) 202310946825.1

(51) Int. Cl. G06F 9/451; G06F 3/0482; G06F 3/0484

(52) U.S. Cl. CPC G06F 9/453; G06F 3/0482; G06F 3/0484; G06F 2203/04803

(57) ABSTRACT

According to embodiments of the present disclosure, methods for information interaction and device and storage medium are provided. In the method for information interaction, a first interactive window for a first user to interact with a digital assistant is displayed in response to an operation of invoking the digital assistant in a first page, and one or more plug-ins selected by default are displayed in the first interactive window, wherein the one or more plug-ins selected by default have a first association relationship with the first page, and each plug-in is configured to perform a corresponding function. Thus, the plug-ins may be selected for a user by default in the interactive window. In this way, diversified operations may be completed efficiently by means of the plug-ins during the user interactions with the digital assistant.

### CROSS-REFERENCE OF RELATED APPLICATION(S)

This application claims priority to Chinese Patent Application No. 202310946825.1, filed Jul. 28, 2023, and entitled “METHOD, APPARATUS, DEVICE, AND STORAGE MEDIUM FOR INFORMATION INTERACTION”, which is incorporated herein by reference in its entirety.

### FIELD

Example embodiments of the present disclosure generally relate to the field of computers, and more particularly, to method and apparatus for information interaction, an electronic device, and a computer-readable storage medium.

### BACKGROUND

With the rapid development of Internet technologies, the Internet has become an important platform for people to obtain content and share the content. A user may access the Internet through a terminal device to enjoy various Internet services. The terminal device presents the corresponding content through a user interface of an application and implements interactions between the user and provides services for the user. Therefore, interactive interfaces of abundant and colorful applications are important means for improving user experience. With the development of information technologies, various terminal devices may provide various services for people in work, life, and other aspects. For example, applications providing the services may be deployed in the terminal devices, and the terminal devices or the applications may provide functions such digital assistant for the user, so as to assist the user in using the terminal devices or the applications. How to improve the flexibility of interactions between the user and the digital assistant is a technical problem to be sought at present.

### SUMMARY

In a first aspect of the present disclosure, there is provided a method for information interaction. The method comprises: in response to an operation of invoking a digital assistant in a first page, displaying a first interactive window for a first user to interact with the digital assistant; and displaying one or more plug-ins selected by default in the first interactive window, wherein the one or more plug-ins selected by default have a first association relationship with the first page, and each plug-in is configured to perform a corresponding function.

In a second aspect of the present disclosure, there is provided a method for information interaction. The method comprises: in response to an operation of invoking a main session window, displaying the main session window for a first user to interact with a digital assistant, and displaying a plug-in selection control in the main session window for selecting a plug-in for use in the main session window; and in response to an operation of invoking the digital assistant in a first page, displaying a first interactive window for the first user to interact with the digital assistant, and displaying the plug-in selection control in the first interactive window for selecting a plug-in for use in the first interactive window.

In a third aspect of the present disclosure, there is provided a method for information interaction. The method comprises: displaying a first plug-in selection control related to a first topic in a session window for a first user to interact with a digital assistant for selecting a plug-in for use in interaction of the first topic, in response to an operation of starting the first topic in the session window; and displaying a second plug-in selection control related to a second topic for selecting a plug-in for use in interaction of the second topic, in response to an operation of starting the second topic in the session window.

In a fourth aspect of the present disclosure, there is provided a method for information interaction. The method comprises: presenting, in an interactive window for a first user to interact with a digital assistant, an interface element related to a plug-in in a topic, a plug-in used in a corresponding topic being selected or viewed via the interface element, and each plug-in is configured to perform a corresponding function; and performing, within the interactive window, a task requested by the first user based on the plug-in selected in a current topic during interaction of the first user with the digital assistant in the current topic.

In a fifth aspect of the present disclosure, there is provided an apparatus for information interaction. The apparatus comprises: a first interactive window displaying module configured to display, in response to an operation of invoking a digital assistant in a first page, a first interactive window for a first user to interact with the digital assistant; and a plug-in displaying module configured to display one or more plug-ins selected by default in the first interactive window, wherein the one or more plug-ins selected by default have a first association relationship with the first page, and each plug-in is configured to perform a corresponding function.

In a sixth aspect of the present disclosure, there is provided an apparatus for information interaction. The apparatus includes: a main session window displaying module configured to display a main session window for a first user to interact with a digital assistant in response to an operation of invoking the main session window, and display a plug-in selection control in the main session window for selecting a plug-in for use in the main session window; and a first interactive window displaying module configured to display, in response to an operation of invoking the digital assistant in a first page, a first interactive window for the first user to interact with the digital assistant, and display the plug-in selection control in the first interactive window for selecting a plug-in for use in the first interactive window.

In a seventh aspect of the present disclosure, there is provided an apparatus for information interaction. The apparatus comprises: a first plug-in selection control displaying module configured to display a first plug-in selection control related to a first topic in a session window for a first user to interact with a digital assistant for selecting a plug-in for use in interaction of the first topic, in response to an operation of starting the first topic in the session window; and a second plug-in selection control displaying module configured to display a second plug-in selection control related to a second topic for selecting a plug-in for use in interaction of the second topic, in response to an operation of starting the second topic in the session window.

In an eighth aspect of the present disclosure, there is provided an apparatus for information interaction. The apparatus comprises: an interface element presenting module configured to present, in an interactive window for a first user to interact with a digital assistant, an interface element related to a plug-in in a topic, through which a plug-in used in a corresponding topic can be selected or viewed, and each plug-in is configured to perform a corresponding function; and a task performing module configured to perform, within the interactive window, a task requested by the first user based on plug-ins selected in a current topic during interaction of the first user with the digital assistant in the current topic.

In a ninth aspect of the present disclosure, there is provided an electronic device. The electronic device comprises: at least one processing unit; at least one memory coupled to the at least one processing unit and storing instructions for execution by the at least one processing unit, the instructions, when executed by the at least one processing unit, cause the electronic device to perform the method of the first aspect, the method of the second aspect, the method of the third aspect, or the method of the fourth aspect.

In a tenth aspect of the present disclosure, there is provided a computer-readable storage medium having a computer program stored thereon, that is executable by a processor to implement the method of the first aspect, the method of the second aspect, the method of the third aspect, or the method of the fourth aspect.

It would be appreciated that the content described in the Summary section of the present invention is neither intended to identify key or essential features of the implementations of the present disclosure, nor is it intended to limit the scope of the present disclosure. Other features of the present disclosure will be readily understood through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure can be implemented;

FIGS. 2A-2C illustrate schematic diagrams of example interfaces of an interactive window according to some embodiments of the present disclosure;

FIGS. 3A and 3B illustrate schematic diagrams of example interfaces of topic interactions according to some embodiments of the present disclosure;

FIGS. 4A-4D illustrate schematic diagrams of multiple examples of plug-in panel interactions according to some embodiments of the present disclosure;

FIGS. 5A and 5B illustrate schematic diagrams of multiple examples of changing interactive operations of plug-ins according to some embodiments of the present disclosure;

FIGS. 6A-6C illustrate schematic diagrams of multiple examples of selecting plug-ins for a topic by default according to some embodiments of the present disclosure;

FIGS. 7A-7E illustrate schematic diagrams of multiple examples of presenting replies of a digital assistant according to some embodiments of the present disclosure;

FIG. 8 illustrates a schematic diagram of one example of presenting usage statuses of plug-ins according to some embodiments of the present disclosure;

FIGS. 9A and 9B illustrate schematic diagrams of multiple examples of plug-in interactions according to some embodiments of the present disclosure;

FIGS. 10A and 10B illustrate schematic diagrams of one example in which a current session stream belongs to a current topic according to some embodiments of the present disclosure;

FIGS. 11A and 11B illustrate schematic diagrams of another example in which a current session stream belongs to a current topic according to some embodiments of the present disclosure;

FIGS. 12A-12D illustrate flowcharts of multiple processes of information interaction according to some embodiments of the present disclosure;

FIGS. 13A-13D illustrate block diagrams of multiple apparatuses for information interaction according to some embodiments of the present disclosure; and

FIG. 14 illustrates a block diagram of an electronic device that is suitable for implementing one or more embodiments of the present disclosure.

### DETAILED DESCRIPTION

The embodiments of the present disclosure will be described in more detail below with reference to the accompanying drawings. Although certain embodiments of the present disclosure are shown in the accompanying drawings, it should be understood that the present disclosure may be implemented in various forms and should not be construed as being limited to the embodiments set forth herein. Conversely, these embodiments are provided for a more thorough and complete understanding of the present disclosure. It should be understood that the accompanying drawings and the embodiments of the present disclosure are for illustrative purposes only and are not intended to limit the scope of protection of the present disclosure.

In the description of the embodiments of the present disclosure, the term “include” and similar terms thereof shall be understood as open inclusion, that is, “include but not limited to”. The term “based on” should be understood as “at least partially based on”. The terms “one embodiment” or “the embodiment” should be understood as “at least one embodiment”. The term “some embodiments” should be understood as “at least some embodiments”. The following may also include other explicit and implicit definitions.

In the specification, unless expressly stated, performing a step “in response to A” does not mean performing the step immediately after “A”, but may include one or more intermediate steps.

It can be understood that data involved in this technical solution (including but not limited to the data itself, and acquisition, usage, storage or deletion of the data) should comply with the requirements of corresponding laws, regulations and relevant provisions.

It can be understood that before using the technical solutions disclosed in the embodiments of the present disclosure, relevant users should be informed of the type, scope of use, and usage scenario, etc. of information involved in the present disclosure in an appropriate manner in accordance with relevant laws and regulations, and the technical solutions should be authorized by the relevant users. The relevant users may include any type of subject of rights, such as an individual, an enterprise, or a group.

For example, in response to receiving an active request from a user, prompt information is sent to the relevant users to clearly remind them that the requested operation will require obtaining and using information about the relevant users, so that the relevant users may, based on the prompt information, autonomously choose whether to provide the information to software or hardware such as an electronic device, an application, a server, or a storage medium, etc. that performs the operations of the disclosed technical solutions.

As an optional but non-limiting implementation, it is a way to send the prompt information to the relevant users in response to receiving active requests from them. For example, it may be in the form of a pop-up window, where the prompt information may be presented in text. In addition, the pop-up window may also carry a selection control for a user to choose between “agree” or “disagree” to provide the information to the electronic device.

It can be understood that the above process of notifying and obtaining user authorization is only schematic and does not constitute a limitation on the implementation of the present disclosure. Other ways that comply with relevant laws and regulations may also be applied to the implementation of the present disclosure.

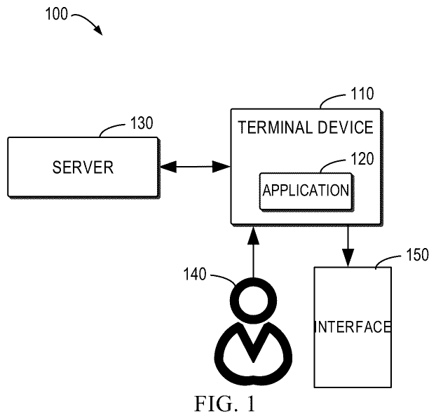

FIG. 1 illustrates a schematic diagram of an example environment 100 in which embodiments of the present disclosure can be implemented. In the example environment 100, an application 120 is installed in a terminal device 110. A user 140 may interact with the application 120 via the terminal device 110 and/or a device attached thereto.

In some embodiments, the application 120 may be downloaded and installed on the terminal device 110. In some embodiments, the application 120 may also be accessed in other ways, such as through a webpage, and so on. In the environment 100 of FIG. 1, if the application 120 is launched, the terminal device 110 may present an interface 150 for the application 120. The interface 150 may include various user interfaces that the application 120 can provide. The interface 150 is also sometimes referred to as a client interface.

The applications 120 include, but are not limited to, one or more of a chat application (also referred to as an instant messaging application), a document application, an audio-video conferencing application, a mail application, a task application, an Objectives and Key Results (OKR) application, and so forth. The application 120 supports the use of plug-ins. Such plug-ins include, but are not limited to, one or more of a search plug-in, a contact plug-in, a message plug-in, a document plug-in, a sheet plug-in, an email plug-in, a calendar plug-in, a schedule plug-in, a task plug-in, and so forth. In some embodiments, the application 120 may include a multifunctional collaborative platform, for example, an office collaborative platform (also referred to as an office suite) can provide integration of multiple types of applications or components, so as to facilitate people's activities such as office and communication. In the multifunctional cooperative platform, the people may launch different applications or components as needed, to complete corresponding information processing, sharing, communication, and the like.

In some embodiments, the terminal device 110 communicates with a server 130 to enable the provision of services to the application 120. The terminal device 110 may be any type of mobile terminal, stationary terminal, or portable terminal, including a mobile phone, a desktop computer, a laptop computer, a notebook, a netbook, a tablet, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a gaming device, or any combination of the above, including accessories and peripherals of those devices or any combination thereof. In some embodiments, the terminal device 110 can also support any type of interface (such as “wearable” circuitry, etc.) targeted for the user. The server 130 may be various types of computing systems/servers capable of providing computing capabilities, including, but not limited to, mainframes, edge computing nodes, computing devices in a cloud environment, and so forth.

It should be understood that the structure and function of various elements in the environment 100 are described for exemplary purposes only, and are not intended to imply any limitation on the scope of the present disclosure.

As mentioned briefly above, a digital assistant may assist a user in using the terminal device or the application. Some applications can provide integrated functionality of different plug-ins. In addition to conducting a free dialogue with the digital assistant, the user may also cause, through natural-language instructions, the digital assistant to use different plug-ins to complete some more complex operations related to services of the application, such as creating a document, inviting a schedule, creating a task, and so on. However, plug-in interworking functions provided by these applications are not flexible enough. For example, in some applications, the plug-ins cannot be selected based on a scenario, a session window, a topic, etc. In other applications, the functionality of searching or viewing the plug-ins may not be provided.

According to some embodiments of the present disclosure, there is provided an improved solution for information interaction. In the embodiments of the present disclosure, an interface element related to a plug-in in a topic are presented in an interactive window for a first user to interact with a digital assistant, the plug-ins used in the corresponding topic can be selected or viewed through the interface elements, and each plug-in is configured to perform a corresponding function. And within the interactive window, a task requested by the first user is performed based on the plug-in selected in a current topic during interaction of the first user with the digital assistant in the current topic. Thus, the plug-ins may be selected, viewed or used to perform the task in the interactive window with the digital assistant. In this way, a variety of interactive operations with the plug-ins may be achieved.

According to some embodiments of the present disclosure, there is provided an improved solution for information interaction. In the embodiments of the present disclosure, a first interactive window for a first user to interact with a digital assistant is displayed in response to an operation of invoking the digital assistant in a first page, and one or more plug-ins selected by default are displayed in the first interactive window, where the one or more plug-ins selected by default have a first association relationship with the first page, and each plug-in is configured to perform a corresponding function. Thus, the plug-ins may be selected by default for the user in the interactive window. In this way, scenario-based intelligent selection of the plug-ins may be achieved.

According to some embodiments of the present disclosure, there is provided an improved solution for information interaction. In the embodiments of the present disclosure, a main session window for a first user to interact with a digital assistant is displayed in response to an operation of invoking the main session window, and a plug-in selection control is displayed in the main session window for selecting a plug-in for use in the main session window, and a first interactive window for the first user to interact with the digital assistant is displayed in response to an operation of invoking the digital assistant in a first page, and a plug-in selection control is displayed in the first interactive window for selecting a plug-in for use in the first interactive window. Thus, a selection of the plug-ins in the main and sub-session windows may be supported. In this way, a flexible selection of the plug-ins based on user's demands may be achieved.

According to some embodiments of the present disclosure, there is provided an improved solution for information interaction. In the embodiments of the present disclosure, a first plug-in selection control related to a first topic is displayed in a session window for a first user to interact with a digital assistant in response to an operation of starting the first topic in the session window, so as to select plug-ins used in interaction of the first topic, and a second plug-in selection control related to a second topic is displayed in response to an operation of starting the second topic in the session window, so as to select plug-ins used in interaction of the second topic. Thus, the plug-ins may be reselected each time a topic is started. In this way, a flexible selection of the plug-ins based on the topics may be achieved.

Some example embodiments of the present disclosure will be described in detail below with reference to examples of the accompanying drawings.

### Example Interactive Window

As described above, in the embodiments of the present disclosure, the digital assistant is used to interact with the user. The interactive window for the user to interact with the digital assistant may be presented in the client interface. The interactive window for the user to interact with the digital assistant may include the session window in which interactions between the user and the digital assistant may be presented in the form of session messages. Alternatively, or additionally, the interactive window for the user to interact with the digital assistant may also include other types of windows, for example, a window in a floating window mode, in which the user may trigger the digital assistant to perform a corresponding operation by inputting an instruction, selecting a shortcut instruction, and the like. As an intelligent assistant, the digital assistant has capabilities of intelligent session and information processing. In the interactive window, the user inputs an interaction message, and the digital assistant provides a reply message in response to the user's input. A client interface for providing the digital assistant may correspond to a single-function application or a multi-function collaborative platform, such as an office suite or other collaborative platforms capable of integrating multiple components.

In some embodiments, a plurality of interactive modes in which the user interacts with the digital assistant may be provided, and flexible switching between the plurality of interactive modes may be possible. In case that a certain interactive mode is triggered, a corresponding interaction area is presented to facilitate the user interactions with the digital assistant. In different interactive modes, the user interacts with the digital assistant in different manners, so that the interaction requirements under different application scenarios can be flexibly adapted.

In some embodiments, the digital assistant may be included as a contact of the user in a contact list of a current user in the office suite, or in an information flow of a chat component. In some embodiments, the user has correspondence with the digital assistant. For example, a first digital assistant corresponds to a first user, a second digital assistant corresponds to a second user, and so on. In some embodiments, the first digital assistant may uniquely correspond to the first user, the second digital assistant may uniquely correspond to the second user, and so on. That is, the first digital assistant of the first user may be specific or belongs to the first user. For example, in a process in which the first digital assistant provides assistance or services to the first user, the first digital assistant may utilize information about its historical interactions with the first user, data authorized by the first user that it can access, a context of its current interactions with the first user, and the like. If the first user is an individual or a person, the first digital assistant may be regarded as a personal digital assistant. It can be understood that, in the embodiments of the present disclosure, the first digital assistant is based on data to which an authorization of the first user is granted access. It should be understood that “uniquely corresponding” or similar expressions in the present disclosure are not intended to limit that the first digital assistant is to be updated accordingly based on an interaction process between the first user and the first digital assistant.

In some embodiments, information processing services specific to the user can be provided based on information about the user's historical interactions with the digital assistant and/or a range of data specific to the user. In some embodiments, historical interaction information of the first user interacting with the first digital assistant in the plurality of interactive modes, respectively, may all be stored in association with the first user. As such, in one (either or a designated one) of the plurality of interactive modes, the first digital assistant may serve the first user based on the historical interaction information stored in association with the first user.

The digital assistant may be invoked or awakened in an appropriate manner (e.g., by a shortcut, a button, or a voice) to present an interactive window for interaction with the user. In some embodiments, the digital assistant may be included as a contact of the user in a contact list of the current user in the application, or in an information flow of the chat application. By selecting the digital assistant, an interactive window for interaction with the digital assistant may be started. The interactive windows may include interface elements for information interaction, such as an input box, a message list, a message bubble, and the like. In some other embodiments, the digital assistant may be invoked through an entrance control or a menu provided in a page, or may also be invoked by inputting a predetermined instruction. In some embodiments described below, for ease of discussion, the description is mainly made by taking the interactive window for the user to interact with the digital assistant being a session window as an example.

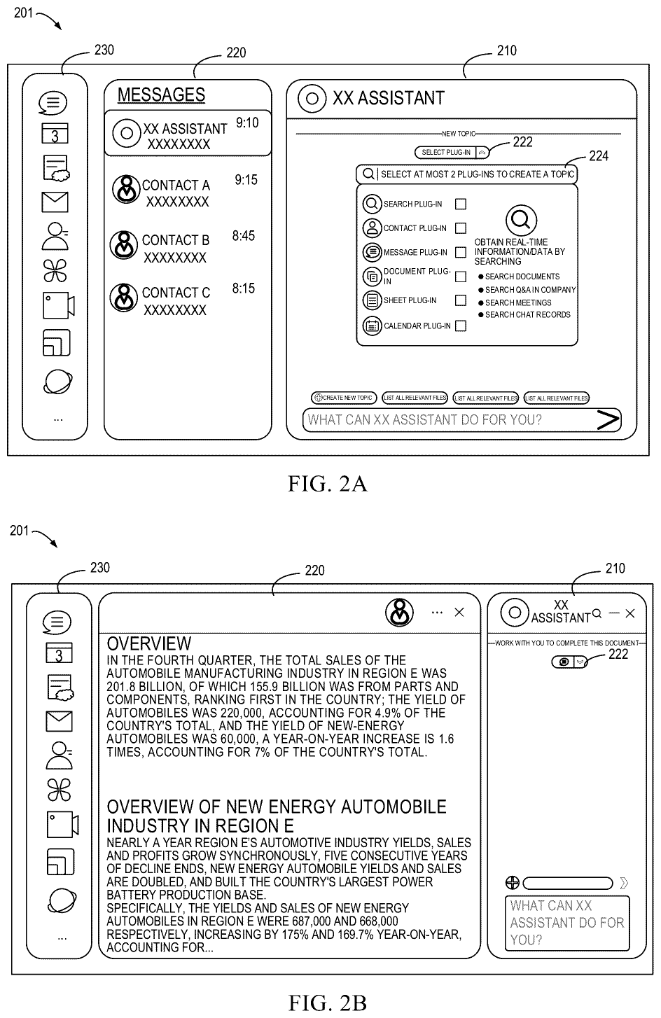

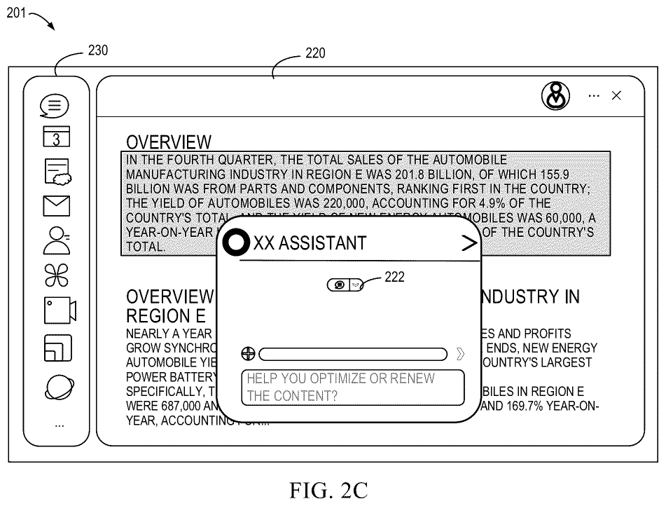

FIGS. 2A-2C illustrate schematic diagrams of an example client interface 201 of an interactive window according to some embodiments of the present disclosure. The client interface 201 may be implemented at the terminal device 110. Examples of FIGS. 2A-2C are described below with reference to FIG. 1.

In some embodiments, the terminal device 110 may display a session window (also referred to as a main session window) for a user (also referred to as a first user) to interact with a digital assistant and a plug-in selection control, in response to the user invoking the digital assistant through a predetermined operation (for example, selecting the digital assistant from a list of contacts). Through such a plug-in selection control, the first user may select plug-ins to be used in the main session window.

In some embodiments, as shown in FIG. 2A, the digital assistant (shown in the figure as “XX Assistant”) is presented in an area 210 of the interface 201 with the user's main session window. The digital assistant may be regarded as one of contacts of the user, and is presented in an information flow of an instant messaging application. The instant messaging application is presented in an area 230 of the interface 201, and the information flow is presented in an area 220 of the interface 201. The user selects the digital assistant in the instant messaging application, thereby entering the main session window, where the main session window includes a plug-in selection control 222. The user may select plug-ins to be used in the session window by clicking on the plug-in selection control 222.

In some embodiments, the terminal device 110 invokes the digital assistant in a first page (for example, a page for browsing documents) and displays a sub-session window (also referred to as a first interactive window) for the first user to interact with the digital assistant, in response to a user's predetermined operation (for example, triggering a predetermined control, inputting a predetermined instruction or voice wakeup, etc.). Such a sub-session window includes a plug-in selection control through which the user may select and use the plug-ins in the sub-session window.

In some embodiments, the interactive window is presented in association with target content. For example, as shown in FIG. 2B, the user selects a document application in the area 230 and views the target content in the document in the area 220. During the viewing, the user invokes the digital assistant, for example, by triggering the predetermined control or menu in 220, or also vocally invokes the digital assistant. In response to such an operation, the terminal device 110 presents the sub-session window for the user to interact with the digital assistant in the area 210 of the interface 201. It should be noted that the area 210 including the sub-session window and the area 220 including the target content are illustrated as being arranged side by side as an example in FIG. 2B and other drawings. In other embodiments, the areas may also be arranged in other ways as needs. For example, the area 210 may be presented on the left side and the area 220 may be presented on the right side in the client interface. As a further example, the areas 210 and 220 may also be arranged in an up-and-down partition manner and the like. The sub-session window includes the plug-in selection control 222. The user may select plug-ins to be used in the session window by clicking on the plug-in selection control 222.

In some embodiments, an application in which the main session window is located and an application in which the sub-session window is located are different applications. For example, the application providing the main session window may be an instant messaging application, which is used for the user to communicate with other users and digital assistants. For example, the application that can invoke the sub-session window may be a reference other than the instant messaging application, such as a document application, a table application, a calendar application, a schedule application, a meeting application, a project management application, a Customer Relationship Management (CRM) application, and the like.

In some embodiments, the terminal device 110 may trigger the digital assistant and present the interactive window in an area where the target content of the first page is displayed. Specifically, as shown in FIG. 2C, after a portion of content 214 of a target document in the area 220 is selected, a menu (not shown) may be displayed by clicking on the right button, where the menu includes an entrance control for the digital assistant. By triggering the entrance control, the interactive window as shown in FIG. 2C may be presented. In this example, the interactive window is presented in a floating window style, and also is known as a floating window interactive window or a floating window session window. Of course, in addition to right-click, the floating window interactive window may also be triggered in various other appropriate manners, which is not limited in the embodiments of the present disclosure. The plug-in selection control 222 may also be displayed in the floating window interactive window, and the user may select plug-ins to be used in the session window by clicking on the plug-in selection control 222.

In some embodiments, the terminal device 110 displays an interactive window (also referred to as a first interactive window) for a user to interact with a digital assistant in response to an operation of invoking the digital assistant in a first page. Such a first interactive window may include a sub-session window and a floating window interactive window. The triggering operations of displaying the sub-session window and the floating window interactive window may be the same or different. For example, in the process of browsing document content by using a document application, if the user invokes the digital assistant through a voice, the terminal device 110 displays the sub-session window in a lateral region of an area where the document content is showed. As a further example, in the process of browsing document content by using the document application, if the user invokes the digital assistant by selecting a certain paragraph of text, the terminal device 110 displays the floating window interactive window in the area where the document content is showed.

In some embodiments, the terminal device 110 may synchronize an interaction message in the first interactive window to the main session window for the user to interact with the digital assistant. For example, the user provides session messages in a sub-session window corresponding to a document application. Then the terminal device 110 may synchronize the session messages in the sub-session window to the main session window when the user switches to use the instant messaging application. In this way, both the user and the digital assistant may be caused to make a better understanding of the context information.

It should be understood that the documents are illustrated as examples of the target content in the drawings. In other embodiments, the target content may also include any other suitable content that may be processed by the platform, including, but not limited to, audio, video, images, emails, calendars, schedules, tasks, and the like. For these contents, the digital assistant may be invoked and present the session window.

FIGS. 2A-2C illustrate multiple examples of starting the session window for the user to interact with the digital assistant. It should be understood that the session window may also be started in other ways. In addition, various specific information, icons, and the like given in FIGS. 2A-2C are also merely examples, and are not intended to limit the scope of the embodiments of the present disclosure.

### Example Topic Interactions

In some embodiments, the terminal device 110 may display plug-in(s) selected by default in the interactive window, whereby the plug-in(s) may be recommended by default based on a scenario. In this manner, it is convenient to respond to user's demands and perform user's tasks efficiently.

If the plug-in(s) selected by default is(are) not displayed in the main session window, as shown in FIG. 2A, the plug-in selection control 222 presents a prompt message “select plug-in”. In some embodiments, if at least one plug-in is selected in a corresponding topic, the terminal device 110 presents identification information of the selected plug-in in an interface element related to the plug-in in the corresponding topic. For example, if the plug-in(s) selected by default is(are) displayed in the session window, as shown in FIGS. 2B and 2C, the plug-in selection control 222 presents the identification information of the selected plug-in(s), such as a bubble icon.

In some embodiments, if the digital assistant is invoked in a first page, the plug-in(s) selected by default has(have) an association relationship (also referred to as a first association relationship) with the first page, and each plug-in is configured to perform a corresponding function (for example, a search plug-in is used for obtaining a message and data matching a search keyword, and a document plug-in is used for performing a task related to a document, such as creating a document). In some embodiments, the first association relationship may also include an association relationship between a history topic of the first user and the digital assistant in the first page. For example, if the user starts a new topic in the application corresponding to the first page, the plug-in(s) selected by default may include one or more plug-ins that are inherited from the historical topics. In some embodiments, such a first association relationship may include an association relationship with a service type of an application providing the first page. For example, for a document application, a document plug-in is a plug-in having the first association relationship therewith. As a further example, for the document application, a plug-in having the first association relationship may further include a “search plug-in”, because the document content may be searched by using the “search plug-in”, which helps the user in processing a target document. Alternatively, or in addition, such a first association relationship may also include an association relationship with a content presented by the first page. For example, if the target document presented by the first page contains a meeting notification. If the digital assistant is invoked in the first page, the plug-in(s) selected by default may include a “schedule plug-in”, and the “schedule plug-in” may be used to conveniently add the meeting notification to a corresponding schedule reminder. Alternatively, or in addition, such a first association relationship may also include an association relationship with a selected portion of the content presented by the first page. For example, the user selects a portion of foreign language sentences in a Chinese document presented on the first page, and after the digital assistant is invoked, the plug-in(s) selected by default may include a “translate plug-in”, so that the selected foreign language sentences can be translated by using the “translate plug-in”. It should be understood that association relationships between applications, page content, and the selected content are given for illustrative purposes only. In practical applications, the specific type, number, etc. of the plug-in(s) selected by default in different scenarios may be set according to specific requirements.

The terminal device 110 further supports user-autonomous selection of plug-ins if the plug-in(s) selected by default is(are) not sufficient to meet the user's demands or the user has newly increased demands. In some embodiments, the terminal device 110 may display the plug-in(s) selected by the user in the interactive window in response to the user's selection operation of the plug-in(s). For example, as shown in FIG. 2B, a “message plug-in” selected by default is displayed in the interactive window (e.g., in a style of bubble). The terminal device 110 displays on the right side of the message plug-in (e.g., in a style of table, not shown) in response to the user clicking on the plug-in selection control 222 and selecting a “sheet plug-in”.

In the session window, the user may enter a message through an input box or by other suitable means (e.g., a voice), and the digital assistant may provide a reply message based on the entered message and in combination with relevant knowledge. Messages in the session window are typically session messages. Such session messages may be regarded as part of a certain topic.

Herein, the “topic” corresponds to a specific context of interactions. During the interactions of each topic, interaction information of the user and the digital assistant is regarded as context information, so as to assist the digital assistant in determining subsequent session messages. In some embodiments, the topic is also referred to or presented as a subject.

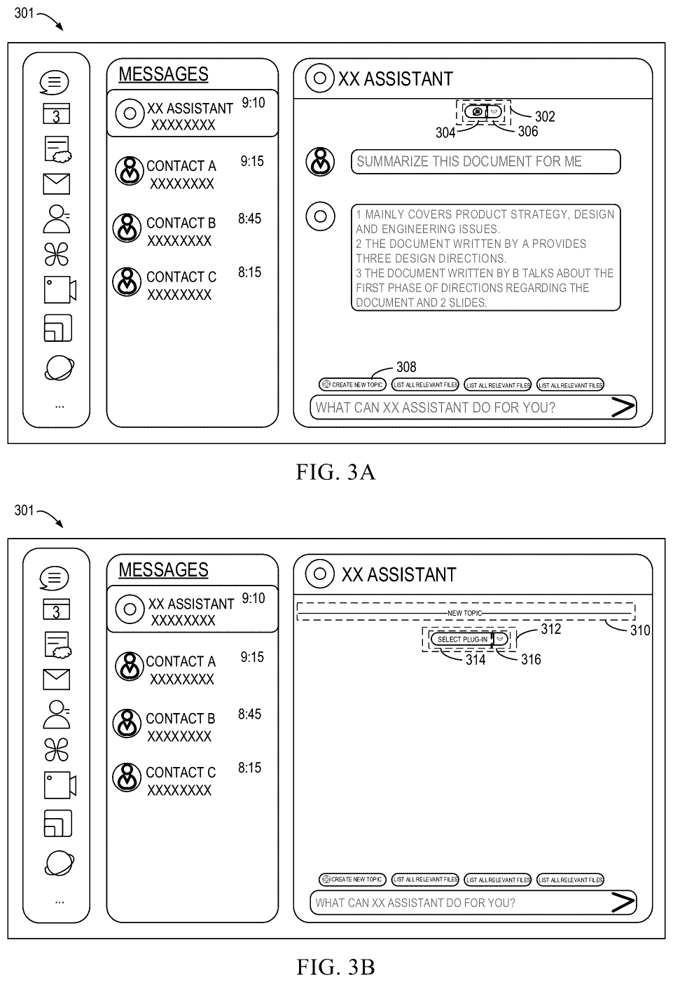

In some embodiments, in the session window for the user to interact with the digital assistant, an interface element related to a plug-in in a topic are presented. FIGS. 3A and 3B illustrate schematic diagrams of example interfaces 301 of topic interactions according to some embodiments of the present disclosure. The main-session window includes session messages of the user and the digital assistant, and the current topic is related to a certain document. In the example of FIG. 3A, the interface elements related to the plug-in in the current topic include an interface element 302 and an interface element 308 (which are sometimes referred to as first interface elements). The user may select or view plug-ins used in the topic through the first interface elements.

In some embodiments, the session window includes interface element related to the plug-in for the current topic, e.g., the interface element 302. The terminal device 110 may present a page for selecting the plug-ins in response to an operation of the user clicking on the interface element 302. For example, as shown in FIG. 3A, such an interface element 302 may be regarded as corresponding to the plug-in selection controls 222 described above with respect to FIGS. 2A-2C. The terminal device 110 may present additional interface elements for selecting plug-in(s) in response to an operation of the user clicking on a sub-interface element 304 or a sub-interface element 306 on the left side of the interface element 302. As a further example, the terminal device 110 may present the plug-in(s) selected by default or already in the sub-interface element 304 (the “message plug-in” of bubble style is shown in the figure).

In some embodiments, the session window includes an interface element, e.g., the interface element 308, for creating the topic. The terminal device 110 may clear the main session window in response to an operation of the user clicking on the interface element 308. As shown in FIG. 3B, by starting a new topic, the context in the previous topic may be segmented, so that the user continues to interact with the digital assistant in the new context.

In some embodiments, by starting the new topic, the user may be allowed to reselect plug-in(s) for use in the new topic. After the new topic is started, the session window also includes associations with plug-in selection in the new topic. For example, as shown in FIG. 3B, the main session window includes an interface element 312. The interface element 312 may be considered to correspond to the plug-in selection control 222 described above with respect to FIGS. 2A-2C. For example, the terminal device 110 may present additional interface elements for selecting plug-in(s) in response to an operation of the user clicking a sub-interface element 314 or a sub-interface element 316 on the left side of the interface element 312. In the session window of FIG. 3B, the user may interact with the digital assistant in the new topic, and the selected plug-in(s) may be used to perform a task requested by the user.

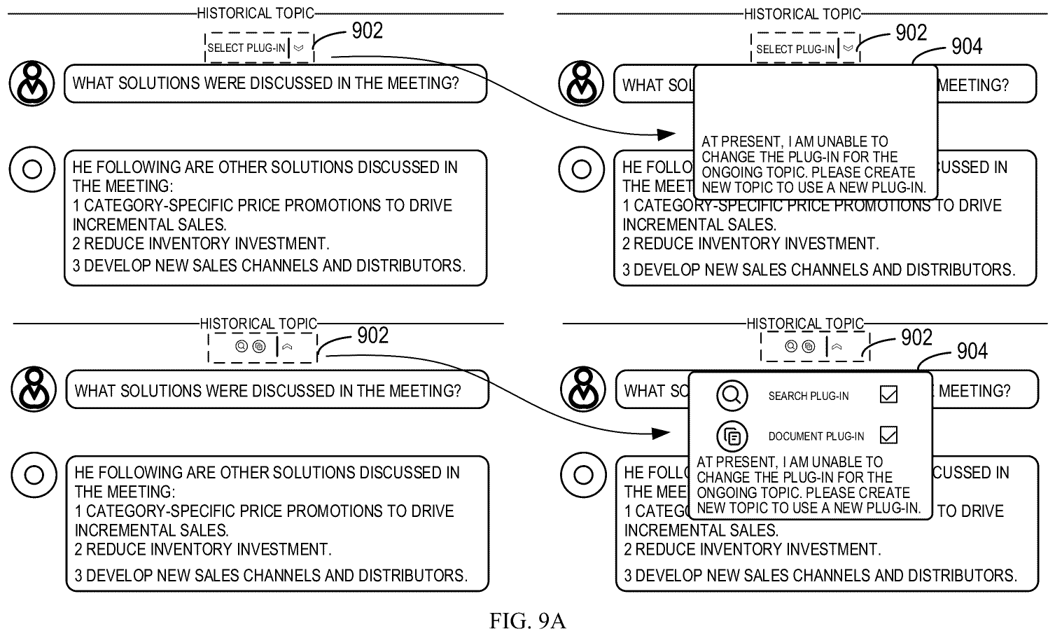

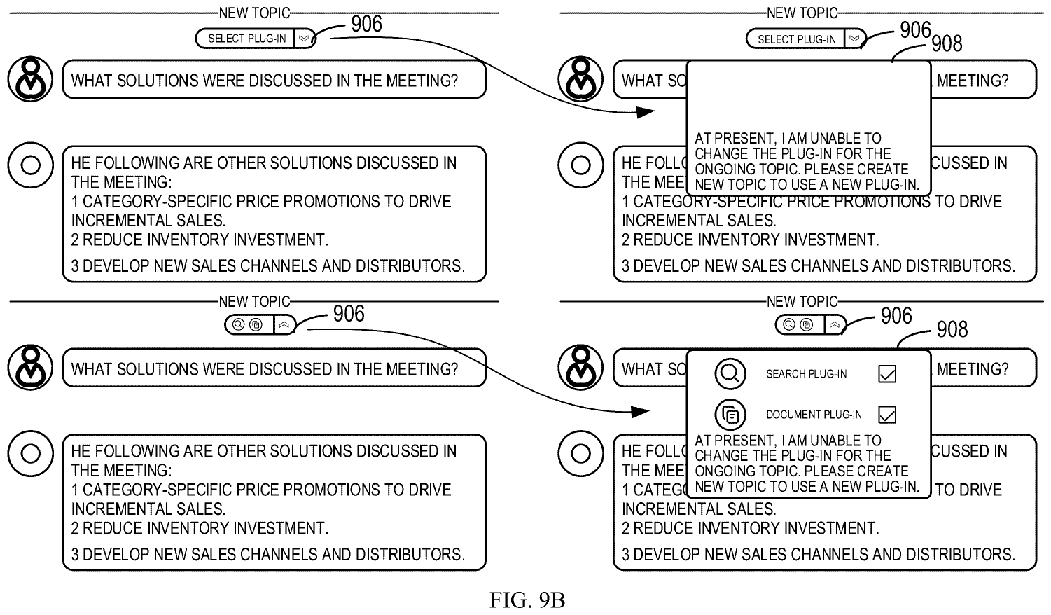

In some embodiments, the session window for the user to interact with the digital assistant may also include interface elements (also sometimes referred to as second interface elements) for viewing a plug-in used in a history topic. For example, the user may scroll a list of messages to view session messages in the history topic and plug-ins used in the history topic. The interface elements for viewing the plug-ins used in the history topic are similar to the interface element 302 shown in FIG. 3A, but would be presented in an area of the session window corresponding to the history topic. In some embodiments, the interface elements for viewing the plug-ins used in the history topic includes a plug-in selection control related to the history topic, but the plug-in selection control allows for viewing plug-ins used in the history topic without allowing the user to change the selected plug-in(s). As an example, a plug-in selection control 902 related to the history topic is shown in FIG. 9A to be described below, where the plug-in selection control 902 may be displayed near a split line of the corresponding history topic.

As previously described, the user may start multiple topics in the session window with the digital assistant as needed. Each time a new topic is started, the user may be allowed to reselect plug-in(s) used in the new topic. In some embodiments, the terminal device 110 may display a first plug-in selection control related to a first topic for selecting a plug-in for use in interaction of the first topic, in response to an operation of starting the first topic in the session window for the user to interact with the digital assistant. Further, the terminal device 110 may also present a second plug-in selection control related to a second topic for selecting a plug-in for use in interaction of the second topic, in response to an operation of starting the second topic in the session window.

In some embodiments, the first plug-in selection control related to the first topic is displayed near a split line of the first topic and a previous topic, and the second plug-in selection control related to the second topic is displayed near a split line of the first topic and the second topic. For example, the user may start multiple topics in one session window and select plug-in(s) to be used multiple times. Each time a new topic is started, a new topic split line is displayed within the session window. The interface elements (e.g., a plug-in selection control of capsule selector style) for selecting and viewing the plug-in(s) are presented below the new topic split line.

In some embodiments, the terminal device 110 may present a split line (also referred to as a separation line or first plug-in selection control) between the first topic and the second topic.

In some embodiments, the terminal device 110 presents the split line on top in response to creating a new topic. For example, after the user creates the new topic, as shown in FIG. 3B, the terminal device 110 clear the main session window to present a new topic split line 310 on top. In some embodiments, the terminal device 110 cancels a presentation of the split line on top in response to at least a portion of the interaction information related to a history topic being presented in the interactive window.

As shown in FIG. 3B, after the new topic is created, the main session window can be cleared and the new topic split line 310 is pinned at the top. When the user inputs and sends a session message for the new topic in the session window, the clear-screen effect will not be revoked. The user may scroll the list of messages to view session messages in the history topic. In some embodiments, the history topic split line is not pinned at the top when it appears in the session window.

### Example Interactions for Plug-In Selection/Viewing

The terminal device 110 may present additional interface elements for selecting plug-in(s), for example, a plug-in selection panel related to a corresponding topic, in response to a user's trigger operation on a first interface element related to a current topic or a second interface element related to a history topic. Such a plug-in selection panel includes a list of plug-ins. Alternatively, or in addition, such interface elements may also include a plug-in selection control through which a presentation of the plug-in selection panel may be triggered.

In some embodiments, the plug-in selection control (also referred to as a first plug-in selection control) of the plug-in selection panel related to the current topic is presented in the session window on top. With continued reference to FIG. 2A, the plug-in selection control 222 is presented below the new topic split line on top, and above the plug-in selection panel 224. In this way, association relationships of both with the current topic are shown.

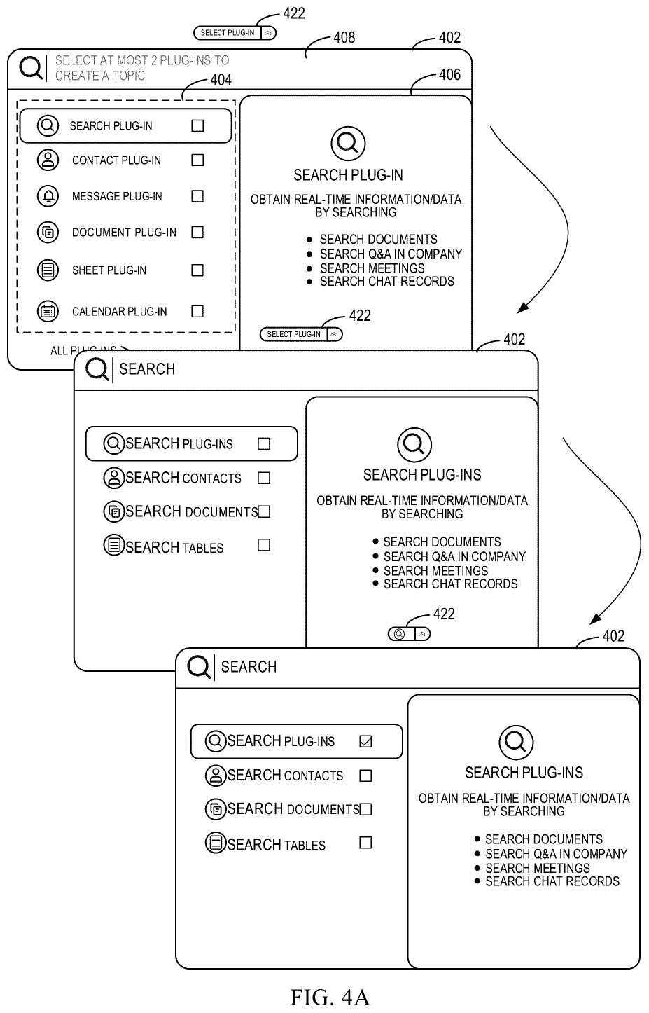

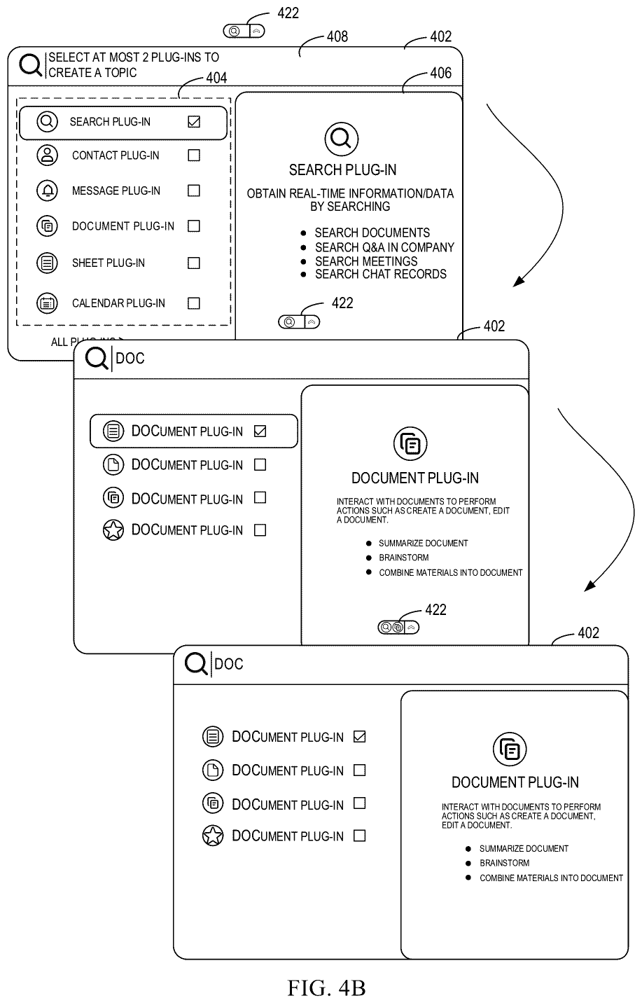

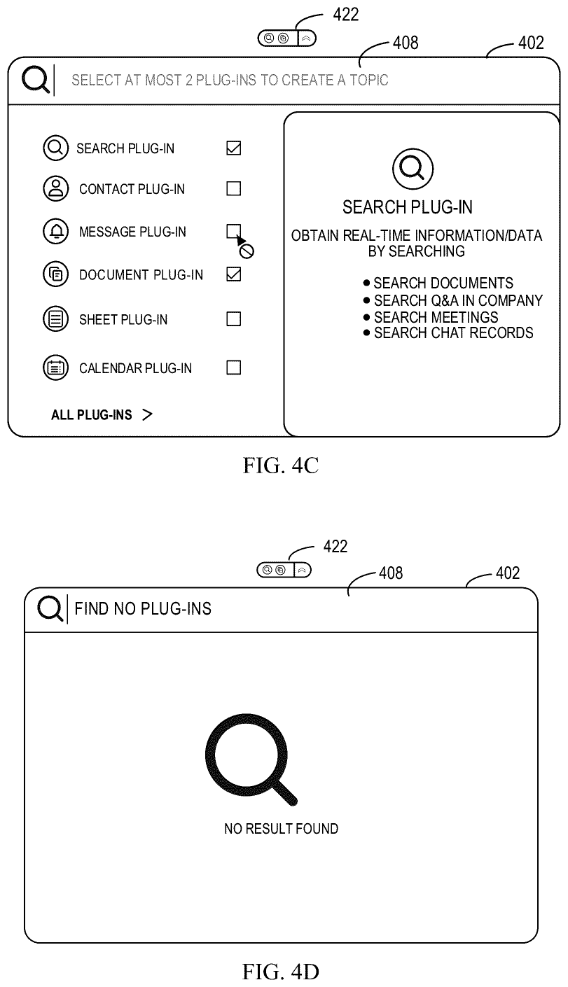

An interactive operation of the plug-in panel will be described below with reference to FIGS. 4A to 4D by taking triggering the plug-in selection panel via the plug-in selection control as an example.

FIGS. 4A-4D illustrate schematic diagrams of multiple examples of plug-in panel interactions according to some embodiments of the present disclosure. As shown in FIGS. 4A-4D, a plug-in selection panel 402 is presented below a plug-in selection control 422. The plug-in selection panel 402 includes a plug-in selection list 404. Such a plug-in selection list 404 includes, for example, a “search plug-in,” a “contact plug-in,” a “message plug-in,” a “document plug-in,” a “sheet plug-in,” a “calendar plug-in,” and the like. Alternatively, or in addition, the plug-in selection list enables sorting of the plug-ins according to the user's usage preferences. For example, a plug-in with a higher search or usage frequency is ranked higher.

In the example of FIG. 4A, these plug-ins are correspondingly provided with check boxes. Identification information of the selected plug-in(s) will be presented in an interface element corresponding to the plug-in selection control 422. For example, after the “search plug-in” is selected, an icon of magnifier style is presented at a corresponding position.

In some embodiments, the terminal device 110 may provide a corresponding details panel in response to a details viewing request for a plug-in (also referred to as a first plug-in) in the list of plug-ins. As shown in FIG. 4A, the plug-in selection panel 402 also includes a details panel 406. The plug-in is highlighted based on a predetermined operation (e.g., a clicking operation) of the user on the “search plug-in”, and the functional description of the plug-in is displayed in the details panel 406.

In some embodiments, a plug-in search function is provided in the plug-in selection panel for searching plug-in(s) from the list of plug-ins. As shown in FIG. 4A, the plug-in selection panel 402 includes a search box 408. The user enters a search term “search” in the search box 408, and search results such as “search plug-in,” “search contact,” “search document,” “search sheet,” etc. are presented in the search list 404. Alternatively, or in addition, the plug-in selection panel provides a fuzzy search functionality.

In some embodiments, a secondary search function for the plug-ins is provided in the plug-in selection panel for searching for plug-in(s) again from the list of plug-ins. In the example of FIG. 4A, the user enters a search term “search” in the search box 408 and selects a “search plug-in” in the search results. The “search plug-in” is presented in the interface element corresponding to the plug-in selection control 422. In the example of FIG. 4B, the user reenters a search term “doc” in the search box 408, and search results such as multiple “document plug-in” are presented in the search list 404. Based on the user's predetermined operation (e.g., a click) on the first “document plug-in”, the plug-in(s) is(are) highlighted and the functional description of the plug-in(s) is displayed in the details panel 406. If the user selects the “document plug-in”, identification information of the plug-in is presented in the interface element corresponding to the plug-in selection control 422. For example, an icon of paper style is presented adjacent to the icon of magnifier style.

In some embodiments, no more than a predetermined number (e.g., 2, 3, or any other suitable number) of plug-ins may be selected. As shown in FIG. 4C, after selecting the “search plug-in” and the “document plug-in”, the check boxes are greyed out and the mouse is rendered as un-selectable.

In some embodiments, the plug-in selection panel includes a prompt message. For example, a message “select at most 2 plug-ins to create 1 topic” is displayed by default in the search box 408. As a further example, a prompt message “No such plug-ins” is displayed in the search box 408 when search results related to the search term entered by the user cannot be provided.

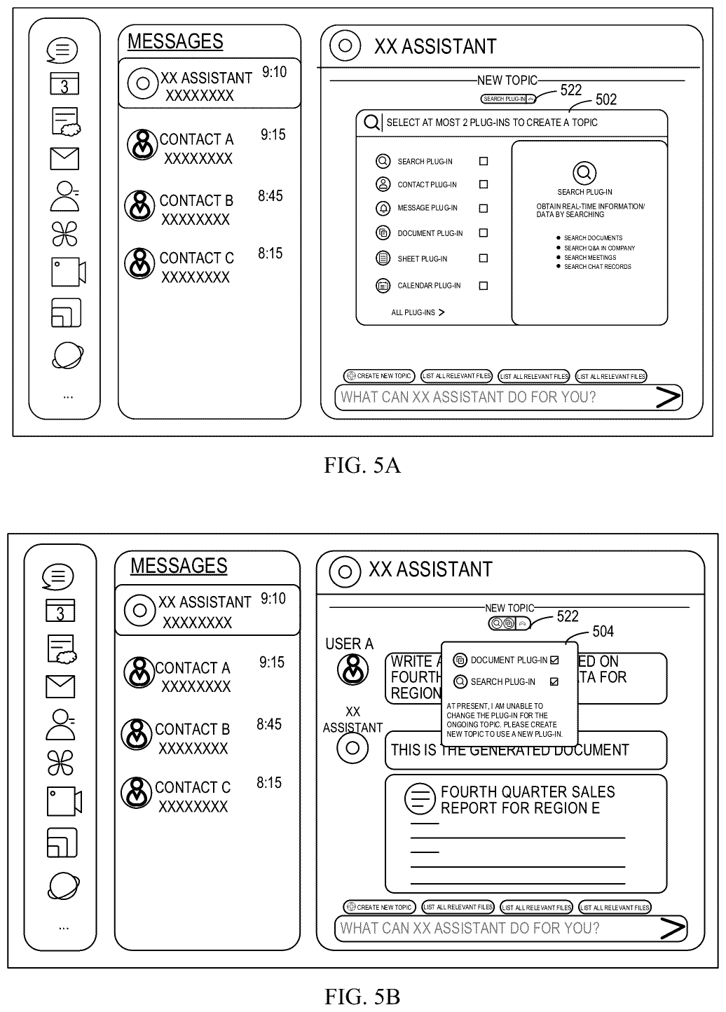

The interactions of the plug-in selection panel are described above in multiple embodiments. By interacting with such a plug-in selection panel, the plug-in(s) may be selected based on the user's demands. In some embodiments, the terminal device 110 may control whether the plug-in(s) that is(are) selected in the current topic may be changed. For example, the plug-in(s) selected and used in the historical topic may no longer be changed, while the plug-in(s) selected in the new topic may be changed. The interactions of changing the plug-in(s) are described below with reference to FIGS. 5A and 5B.

In some embodiments, the terminal device 110 disables changes to the plug-in(s) selected in the current topic in response to receiving at least one session message in the current topic. That is, the user is no longer allowed to change the plug-in(s) used in the ongoing topic if there are already one or more rounds of interaction in the newly started topic. As shown in FIG. 5A, the user creates a new topic and selects plug-in(s) from the plug-in selection panel 502. If the current message list is empty, the terminal device 110 supports the user in reselecting the plug-in. As shown in FIG. 5B, after the user creates a new topic and selects plug-in(s) from the plug-in selection panel 502, the terminal device 110 presents identification information of the selected plug-in(s) in an interface element corresponding to the plug-in selection control 522. If a session message is received in the current message list, as shown in FIG. 5B, the terminal device 110 does not support the user in changing the selected plug-in(s). Alternatively, or in addition, the terminal device 110 presents the plug-in viewing panel 502 in response to a predetermined operation (e.g., a clicking operation) of the user on the plug-in selection control 522. Alternatively, or in addition, the terminal device 110 may present a prompt message reminding the user that a change to the selected plug-in(s) is not supported, e.g., “At present, I am unable to change the plug-in for the ongoing topic. Please create a new topic to use a new plug-in.”

In some embodiments, interaction of the first user with the digital assistant in a topic of the interactive window is performed at least in a context of the target content, and the plug-in(s) selectable in the topic of the interactive window is(are) determined based on the target content. For example, in a document application, selectable plug-in(s) is(are) determined by content in the document and presented to the user in the plug-in panel. Thus, plug-ins that have a strong association with the target content may be preliminarily screened out. In this way, the interaction efficiency may be improved.

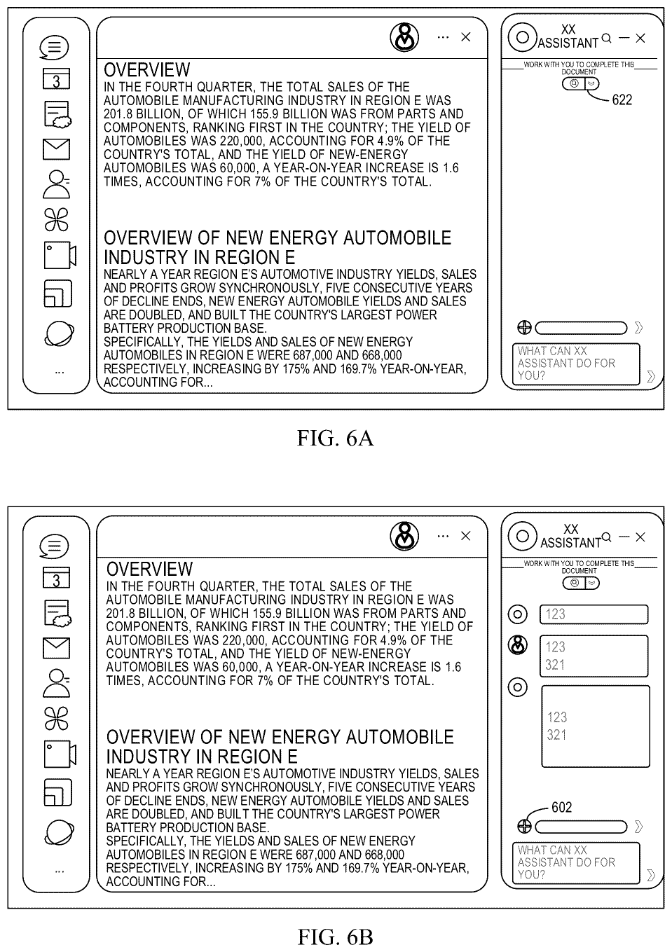

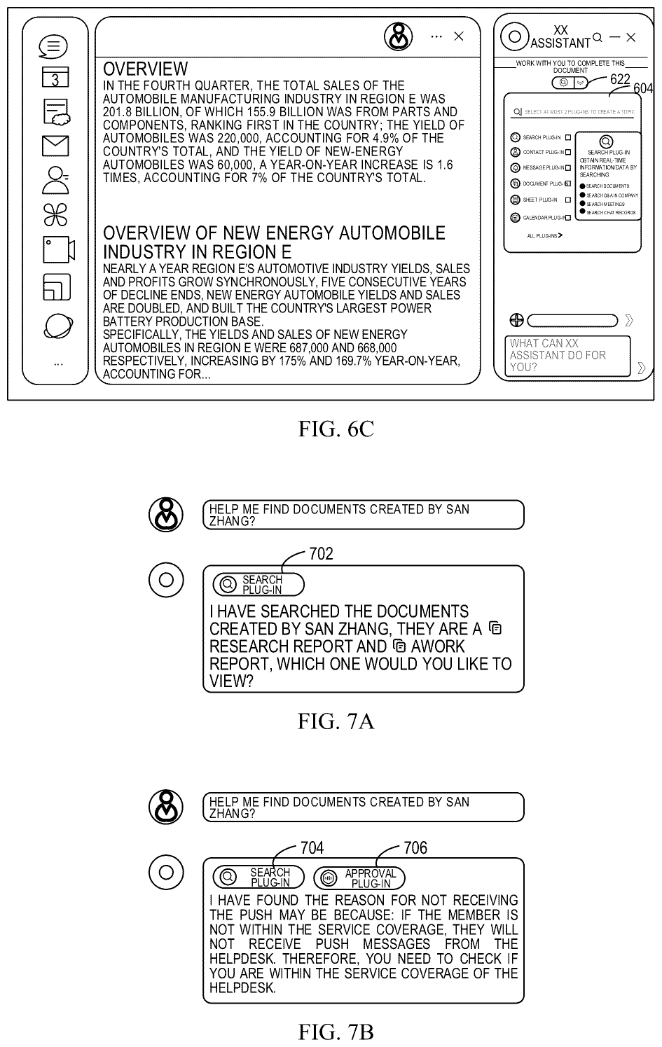

FIGS. 6A-6C illustrate schematic diagrams of multiple examples of plug-ins selected by default for a topic according to some embodiments of the present disclosure. In some embodiments, at least one plug-in is selected by default for a first topic in the interactive window. As shown in FIG. 6A, in the first topic in the sub-session window, the “search plug-in” is selected by default, and identification information of the “search plug-in” is presented in an interface element corresponding to a plug-in selection control 622.

In some embodiments, if a new topic is triggered in the interactive window, at least one plug-in is selected by default for the new topic. As shown in FIG. 6B, the current topic is presented in the sub-session window, and the terminal device 110 may, in response to an operation of the user clicking on the interface element 602, as shown in FIG. 6A, clear the sub-session window and present plug-in(s) selected by default on top. Such plug-in(s) selected by default may be determined based on the user's individual usage preferences. For example, if the user frequently uses the “search plug-in”, then the “search plug-in” may be presented by default when creating a new topic. In this way, the interactive manner may be made more compliant to the user's demands.

In some embodiments, the terminal device 110, in response to the user creating a new topic in the sub-session window, loads default plug-ins in according to the application or target content in the application and supports freely editing by the user. For example, the “calendar plug-in” may be loaded if the target content presented in the document application relates to meeting notifications. The user may also change the plug-in(s) selected by default to the required plug-in(s). For example, as shown in FIG. 6C, the terminal device 110 presents a plug-in selection panel 604 in response to an operation of the user clicking on the plug-in selection control 622. The user may select the required plug-in(s), such as the “message plug-in”, in the plug-in selection panel 604.

In some embodiments, the terminal device 110 loads in default plug-ins according to the application or the target content in the application and does not support free editing by the user, in response to creating a new topic in the floating window interactive window.

### Identification of Plug-Ins in Interactions

The task requested by the user may be performed based on the selected plug-in(s). In order to make the user clearly know the function of the plug-in(s) or by which plug-in the current task is performed, in some embodiments, a reply (also referred to as a first reply) of the digital assistant is presented in the interactive window. Such a reply includes the execution result of the task and identification information of the plug-in used for performing the task.

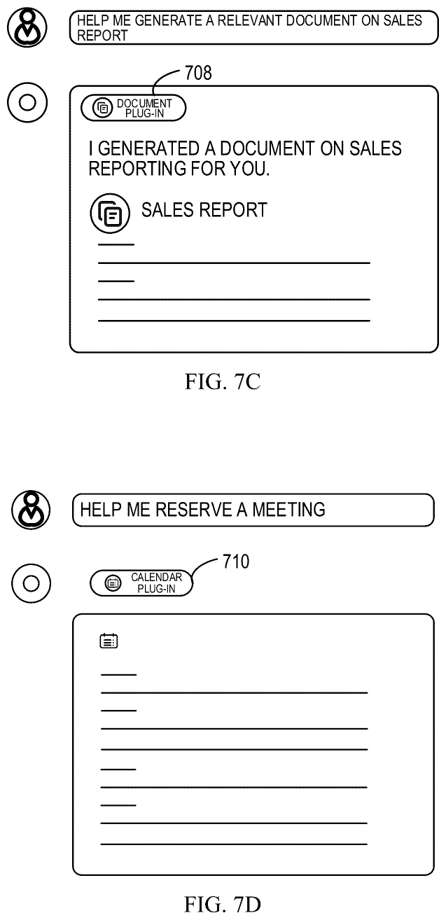

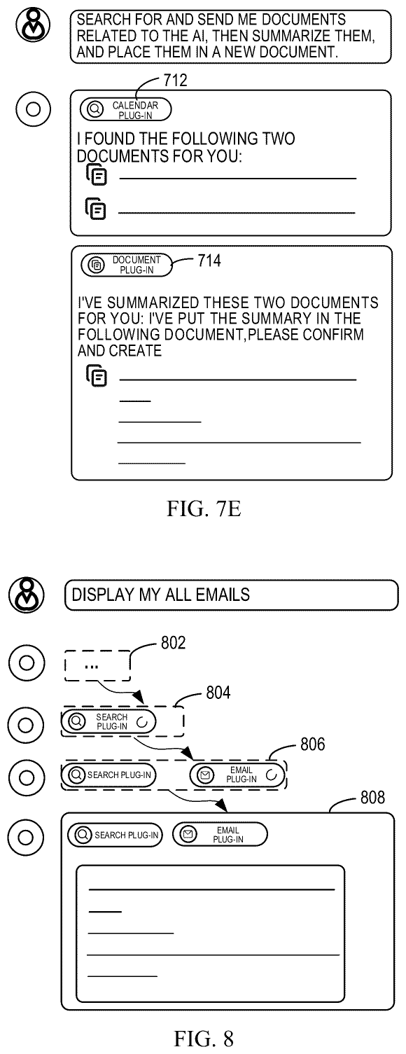

FIGS. 7A-7E illustrate schematic diagrams of multiple examples of presenting replies of a digital assistant according to some embodiments of the present disclosure. As shown in FIG. 7A, the user requests to perform a search task, for example, “Help me find a document created by San Zhang.” The execution result of the search task is presented in a session message of the digital assistant, and identification information 702 corresponding to the “search plug-in” used to perform the search task is also presented.

As shown in FIG. 7B, the user requests to perform a task, e.g., determining the reason why I did not receive an approval push. The execution result of the task is presented in the session message of the digital assistant, and identification information 704 corresponding to the “search plug-in” and identification information 706 corresponding to the “approval plug-in” for performing the task are also presented.

As illustrated in FIG. 7C, the user requests to perform a task of generating a sales report, such as “help me generate a relevant document about the sales report.” The execution result of the task is presented in a session message of the digital assistant, and identification information 708 corresponding to the “document plug-in” for performing the task is also presented.

In the example of FIGS. 7A-7B, the identification information corresponding to the plug-in is presented in a session message and presented on top. In the example of FIG. 7D, the user requests to perform a task of reserving a meeting, for example, “help me reserve a meeting.” The execution result of the task is presented in a session message of the digital assistant, and identification information 710 corresponding to the “calendar plug-in” for performing the task is presented above the session message. In some scenarios, if more time is required to perform a task, in order to reduce the waiting anxiety of the user, identification information corresponding to the plug-in used for performing the task may be presented first, and after a task execution result is obtained, a session message is presented below the identification information.

In some scenarios, the task requested by the user to be performed involves multiple subtasks, such as “Search for and send me documents related to the AI, then summarize them, and place them in a new document.” The execution result of the first subtask in the task is presented in a first session message of the digital assistant, and identification information 712 corresponding to the “search plug-in” used to perform the subtask is also presented. Next, the execution result of the second subtask in the task is presented in a second session message of the digital assistant, and identification information 714 corresponding to the “document plug-in” for performing the subtask is also presented.

In some scenarios, considering that the number of plug-ins involved and the workflow for performing the task are linear, the plug-ins currently in use may be leaked out one by one in order. When the plug-ins are provided, only the identification information corresponding to the plug-ins may be displayed, and more information corresponding to the plug-ins may also be displayed, such as function information.

In some embodiments, a plug-in usage status is presented in the interactive window during the generation of the first reply. Such a plug-in usage status indicates the plug-in being used. FIG. 8 illustrates a schematic diagram of one example of presenting a plug-in usage status according to some embodiments of the present disclosure. In the example of FIG. 8, the user requests to perform a task, such as “display all my emails.” The digital assistant first presents a first session message 802, for example, indicating with an ellipsis that corresponding plug-ins are being sought. Then, the digital assistant presents a second session message 804, where the second session message 804 includes identification information corresponding to the “search plug-in”, so as to indicate starting to use the “search plug-in” to perform the first subtask corresponding to the task. Next, the digital assistant presents a third session message 806, where the third session message 806 includes identification information corresponding to the “document plug-in”, so as to indicate that the second subtask corresponding to the task starts to be performed by using the “document plug-in.” Finally, the digital assistant presents a fourth session message 808 to present the execution results of the task and identification information of the used plug-in(s).

### Other Example Interactions

FIGS. 9A and 9B illustrate schematic diagrams of multiple examples of plug-in interactions according to some embodiments of the present disclosure. In the example of FIG. 9A, a plug-in selection control 902 associated with a history topic is presented as a lightweight style, such as a border of removed capsule selector style. The terminal device 110 presents a plug-in viewing panel 904 in response to an operation of the user clicking on the plug-in selection control 902. In case that no plug-in is selected, the plug-in viewing panel 904 presents only prompt information, and in case that a selected plug-in exists, the plug-in viewing panel 904 presents the corresponding plug-in and prompt information.

In the example of FIG. 9B, a plug-in selection control 906 in a new topic is presented as a capsule selector style. The terminal device 110 presents a plug-in viewing panel 908 in response to an operation of the user clicking on the plug-in selection control 906. In case that no plug-in is selected, the plug-in viewing panel 908 presents only prompt information, and in case that a selected plug-in exists, the plug-in viewing panel 908 presents the corresponding plug-in and prompt information.

In some embodiments, if the current session stream belongs to the current topic, the plug-in selection control is attached at the top of the interactive window.

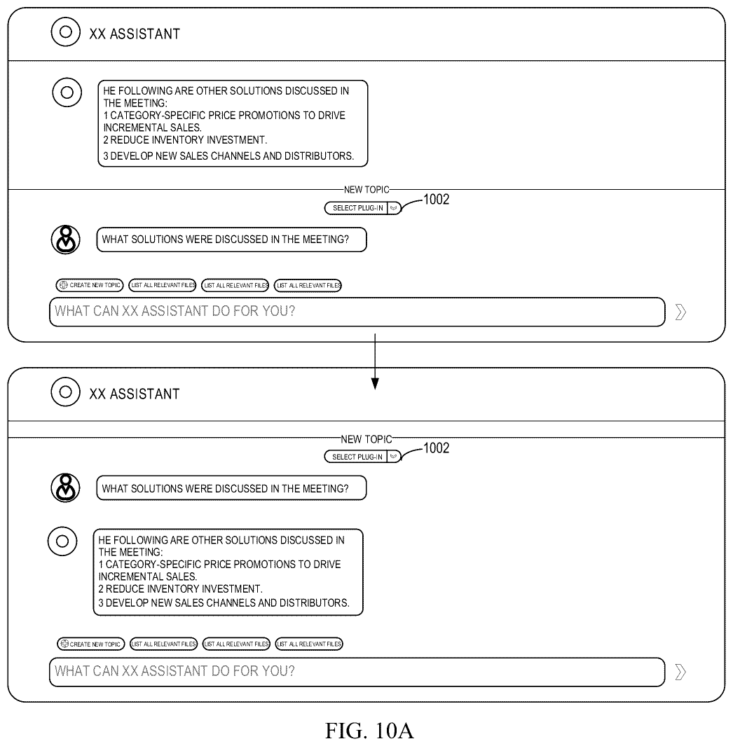

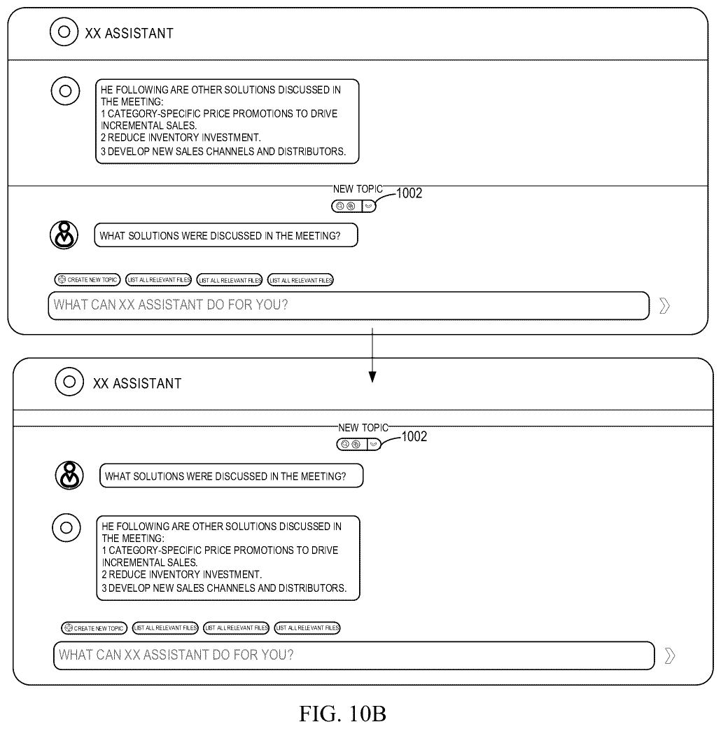

FIGS. 10A and 10B illustrate schematic diagrams of one example where a current session stream belongs to a current topic according to some embodiments of the present disclosure. The example in FIG. 10A corresponds to a case in which no selected plug-in exists in an interface element corresponding to a plug-in selection control 1002, and the example of FIG. 10B corresponds to a case in which an interface element corresponding to the plug-in selection control 1002 displays a selected plug-in. In the example of FIG. 10A, the current session stream belongs to the current topic, when the list of messages is scrolled, the plug-in selection control 1002 is pinned near a topic split line if both a historical session stream and the current session stream are presented at the same time. If only the current session stream is presented, the plug-in selection control 1002 is attached at the top of the session window.

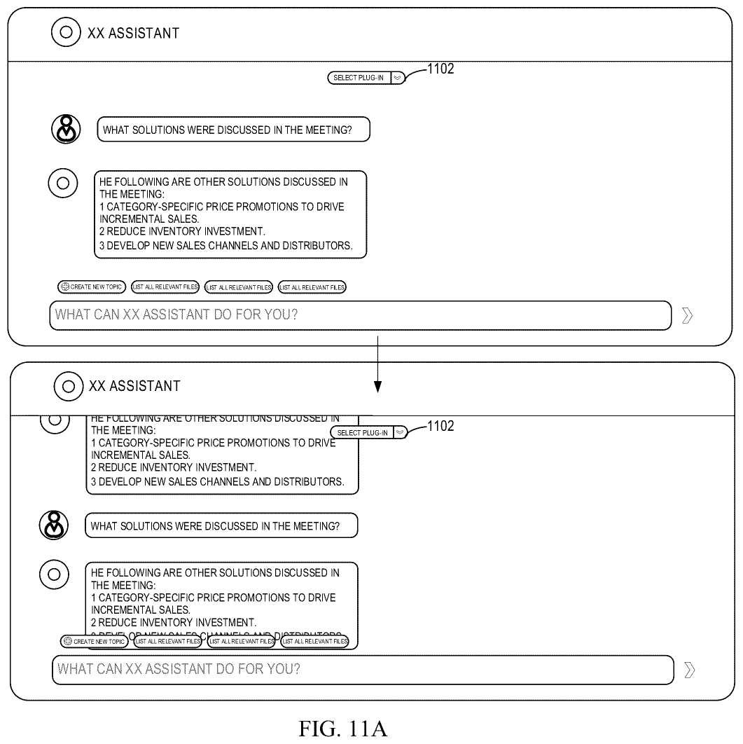

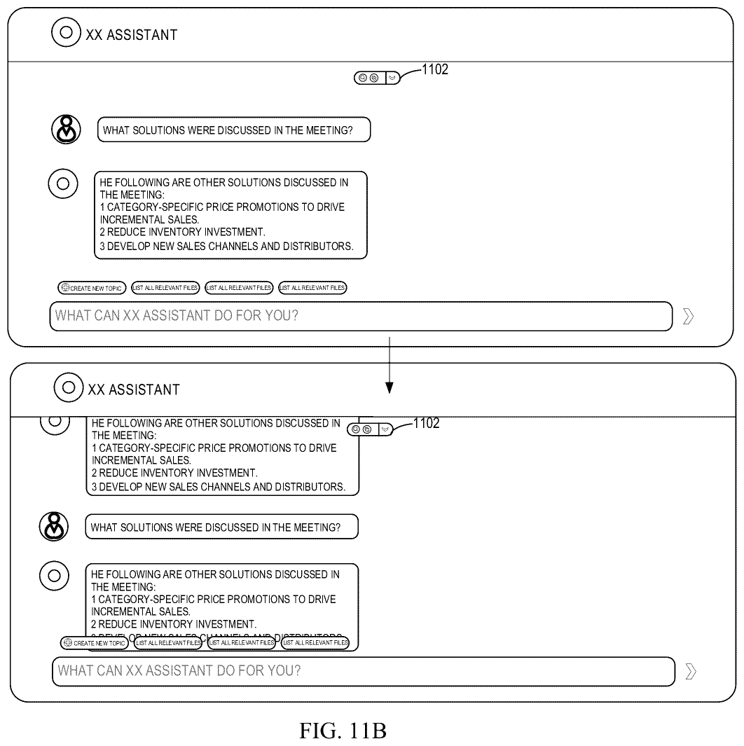

FIGS. 11A and 11B illustrate schematic diagrams of another example where a current session stream belongs to a current topic according to some embodiments of the present disclosure. The example of FIG. 11A corresponds to a case in which no selected plug-in exists in an interface element corresponding to a plug-in selection control 1102, and the example of FIG. 11B corresponds to a case in which the interface element corresponding to the plug-in selection control 1102 displays a selected plug-in. In the examples of FIGS. 11A and 11B, the current session stream belongs to the current topic, when the list of messages is scrolled, only the current session stream is seen, and the plug-in selection control 1102 always attach at the top of the session window.

In some embodiments, the plug-in selection control returns to the session flow if the current session flow does not belong to the current topic. For example, when scrolling the list of messages, only a historical session stream is presented, and the plug-in selection control is fixed near the topic split line and follows the scrolling.

In conclusion, according to various embodiments of the present disclosure, during an interaction process between a user and a digital assistant, the user is supported to select and use a plug-in in an interactive window (such as a main session window, a sub-session window, or a floating window interactive window). For the sub-session window, plug-ins selected by default may be recommended to the user based on the context of the application, and the user may also be supported to change the plug-ins selected by default. Further, it is supported that the user may select the plug-ins to be used multiple times by starting a new topic in the same session window. Also provided is a plug-in selection panel for a user to search for a plug-in. In this way, the plug-in may be flexibly selected based on scenarios, the user's demands and topics, thereby realizing diversified interactive operations with the plug-in.

It should be understood that some embodiments of the present disclosure have been described above in conjunction with specific examples in the drawings, but these specific examples are not intended to limit the scope of the embodiments of the present disclosure. The described embodiments may also be implemented in various other variants.

### Example Processes

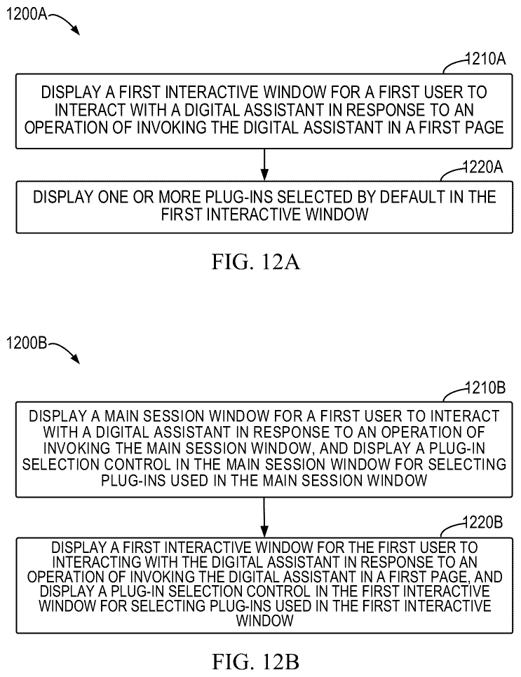

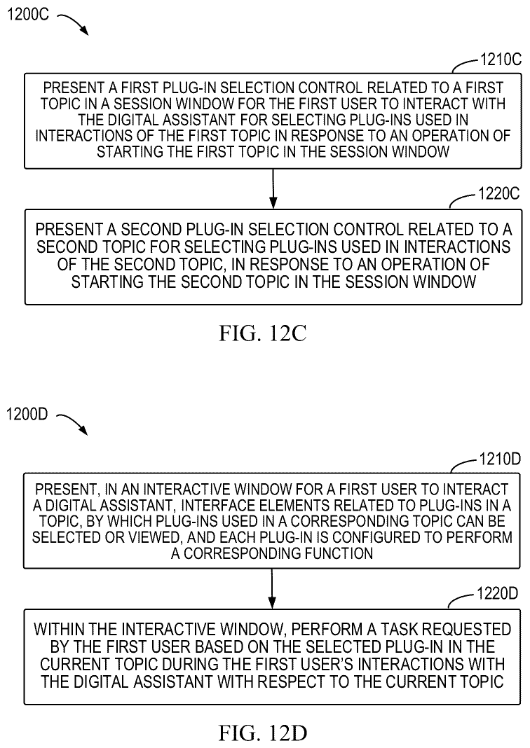

FIG. 12A illustrates a flowchart of a process 1200A for information interaction according to some embodiments of the present disclosure. The process 1200A may be implemented at the terminal device 110. For ease of discussion, the process 1200A will be described with reference to the environment 100 of FIG. 1.

At block 1210A, the terminal device 110 displays a first interactive window for a first user to interact with a digital assistant in response to an operation of invoking the digital assistant in a first page. At block 1220A, one or more plug-ins selected by default are displayed in the first interactive window, where the one or more plug-ins selected by default have a first association relationship with the first page, and each plug-in is configured to perform a corresponding function.

In some embodiments, the terminal device 110 displays a main session window for the first user to interact with the digital assistant in response to an operation of invoking the main session window, where an application providing the main session window and an application providing the first page are different applications.

In some embodiments, the method 1200A further includes one or more of: displaying a plug-in selection control in the main-session window; synchronizing an interaction message in the first interactive window to the main session window for first user to interact with the digital assistant.

In some embodiments, the terminal device 110 displays plug-in(s) selected by the user in the first interactive window in response to a plug-in selection operation of the user.

In some embodiments, the first association relationship includes one or more of: an association relationship with a service type of an application providing the first page, an association relationship with a content presented by the first page, an association relationship with a selected portion of the content presented by the first page, and an association relationship between a history topic of the first user and the digital assistant in the first page.

FIG. 12B illustrates a flowchart of a process 1200B for information interaction according to some embodiments of the present disclosure. The process 1200B may be implemented at the terminal device 110. For ease of discussion, the process 1200B will be described with reference to the environment 100 of FIG. 1.

At block 1210B, the terminal device 110 displays a main session window for a first user to interact with a digital assistant in response to an operation of invoking the main session window, and displays a plug-in selection control in the main session window for selecting a plug-in for use in the main session window. At block 1220B, a first interactive window for the first user to interacting with the digital assistant is displayed in response to an operation of invoking the digital assistant in a first page, and a plug-in selection control is displayed in the first interactive window for selecting a plug-in for use in the first interactive window.

FIG. 12C illustrates a flowchart of a process 1200C for information interaction according to some embodiments of the present disclosure. The process 1200C may be implemented at the terminal device 110. For ease of discussion, the process 1200C will be described with reference to the environment 100 of FIG. 1.

At block 1210C, the terminal device 110 presents a first plug-in selection control related to a first topic in a session window for the first user to interact with the digital assistant for selecting a plug-in for use in interactions of the first topic in response to an operation of starting the first topic in the session window. At block 1220C, a second plug-in selection control related to a second topic is presented for selecting a plug-in for use in interaction of the second topic, in response to an operation of starting the second topic in the session window.

In some embodiments, the first plug-in selection control related to the first topic is displayed near a split line of the first topic and a previous topic, and the second plug-in selection control related to the second topic is displayed near a split line of the first topic and the second topic.

FIG. 12D illustrates a flowchart of a process 1200D for information interaction according to some embodiments of the present disclosure. The process 1200D may be implemented at the terminal device 110. For ease of discussion, the process 1200D will be described with reference to the environment 100 of FIG. 1.

At block 1210D, the terminal device 110 presents, in an interactive window for a first user to interact a digital assistant, an interface element related to a plug-in in a topic, a plug-in used in a corresponding topic being selected or viewed via the interface element, and each plug-in is configured to perform a corresponding function. At block 1220D, within the interactive window, a task requested by the first user is performed based on the selected plug-in in the current topic during interaction of the first user with the digital assistant in the current topic.

In some embodiments, in response to an operation of starting a current topic in the interactive window, the terminal device 110 presents a first interface element related to the plug-in in the current topic, through which a plug-in used in the current topic can be selected.

In some embodiments, the plug-in used in a history topic may be viewed by a second interface element associated with a plug-in in the history topic in the interactive window.

In some embodiments, the terminal device 110 disables a change to the plug-in selected in the current topic in response to receiving at least one session message in the current topic.

In some embodiments, the interface element related to the plug-in in the topic include at least one of: a plug-in selection panel related to the corresponding topic, a plug-in selection panel including a list of plug-ins, or a plug-in selection control through which a presentation of the plug-in selection panel is triggered.

In some embodiments, a first plug-in selection control of the plug-in selection panel related to the current topic is presented on top in the interactive window.

In some embodiments, the terminal device 110 cancels the on-top presentation of the first plug-in selection control in response to at least a portion of the interaction information related to a history topic being presented in the interactive window.

In some embodiments, a plug-in search function is provided in the plug-in selection panel for searching a plug-in from the list of plug-ins.

In some embodiments, the terminal device 110 provides a details panel of a first plug-in in the list of plug-ins in response to a details viewing request for the first plug-in, where the details panel includes at least a description of a function of the first plug-in.

In some embodiments, the interactive window is presented in association with target content, interaction of the first user with the digital assistant in a topic of the interactive window is performed at least in a context of the target content, and where the plug-ins selectable in the topic of the interactive window are determined based on the target content.

In some embodiments, if a new topic is triggered in the interactive window, at least one plug-in is selected by default for the new topic.

In some embodiments, if the at least one plug-in is selected in the corresponding topic, interface element related to the plug-in in the corresponding topic include identification information of one or more of the at least one plug-in.

In some embodiments, the terminal device 110 presents a first reply of the digital assistant in the interactive window, where the first reply includes an execution result of the task and identification information of plug-ins used for performing the task.

In some embodiments, the terminal device 110 presents a plug-in usage status in the interactive window during the generation of the first reply, where the plug-in usage status indicates the plug-in being used.

### Example Apparatuses and Devices

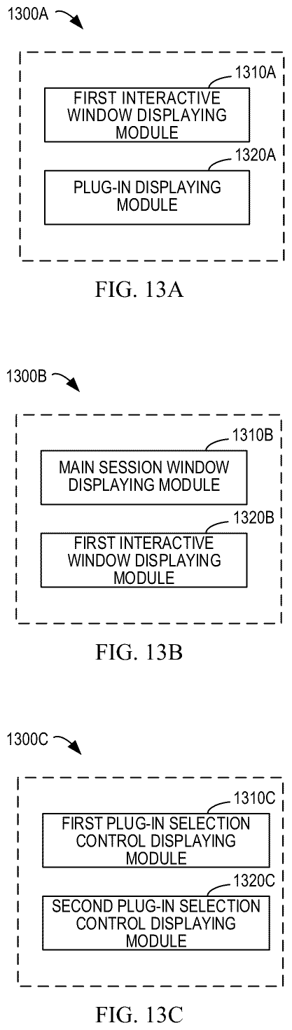

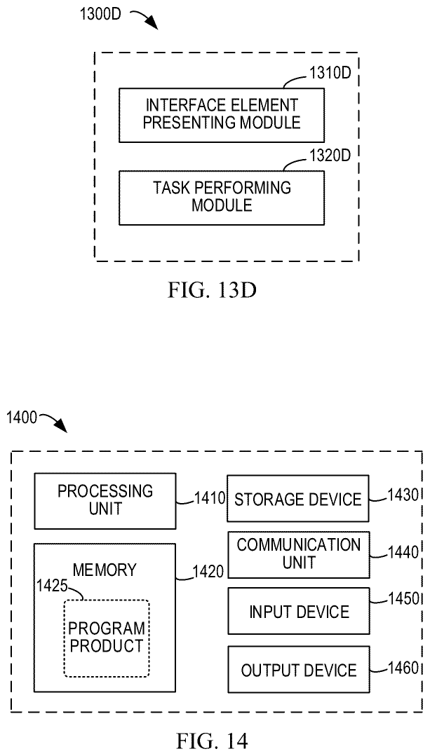

FIG. 13A illustrates a schematic structural block diagram of an apparatus 1300A for information interaction according to some embodiments of the present disclosure. The apparatus 1300A may be implemented as or included in the terminal device 110. Various modules/components in the apparatus 1300A may be implemented by hardware, software, firmware or any combination thereof.

The apparatus 1300A includes a first interactive window displaying module 1310A configured to display, in response to an operation of invoking a digital assistant in a first page, a first interactive window for a first user to interact with the digital assistant. The apparatus 1300A further includes a plug-in displaying module 1320A configured to display one or more plug-ins selected by default in the first interactive window, where the one or more plug-ins selected by default have a first association relationship with the first page, and each plug-in is configured to perform a corresponding function.

In some embodiments, the apparatus 1300A further includes a main session window displaying module configured to display a main session window for the first user to interact with the digital assistant in response to an operation of invoking the main session window, where an application providing the main session window and an application providing the first page are different applications.

In some embodiments, the apparatus 1300A further includes: a plug-in selection control displaying module configured to display a plug-in selection control in the main session window; and/or an interactive message synchronization module configured to synchronize interactive messages in the first interactive window to the main session window for the first user to interact with the digital assistant.

In some embodiments, the apparatus 1300A further includes a user-selected plug-in displaying module configured to display a plug-in selected by the user in the first interactive window in response to a plug-in selection operation of the user.

In some embodiments, the first association relationship includes one or more of: an association relationship with a service type of an application providing the first page, an association relationship with a content presented by the first page, an association relationship with a selected portion of the content presented by the first page, and an association relationship between a history topic of the first user and the digital assistant in the first page.

FIG. 13B illustrates a schematic structural block diagram of an apparatus 1300B for information interaction according to some embodiments of the present disclosure. The apparatus 1300B may be implemented as or included in the terminal device 110. The various modules/components in the apparatus 1300B may be implemented by hardware, software, firmware, or any combination thereof.

The apparatus 1300B includes a main session window displaying module 1310B configured to display a main session window for a first user to interact with a digital assistant in response to an operation of invoking the main session window, and display a plug-in selection control in the main session window for selecting a plug-in for use in the main session window. The apparatus 1300B further includes a first interactive window displaying module 1320B configured to present, in response to an operation of invoking the digital assistant in a first page, a first interactive window for the first user to interact with the digital assistant, and present the plug-in selection control in the first interactive window for selecting a plug-in for use in the first interactive window.

FIG. 13C illustrates a schematic structural block diagram of an apparatus 1300C for information interaction according to some embodiments of the present disclosure. The apparatus 1300C may be implemented as or included in the terminal device 110. The various modules/components of the apparatus 1300C may be implemented by hardware, software, firmware, or any combination thereof.

The apparatus 1300C includes a first plug-in selection control displaying module 1310C configured to display a first plug-in selection control related to a first topic in a session window for a first user to interact with a digital assistant in response to an operation of starting the first topic in the session window, for selecting a plug-in for use in interactions of the first topic. The apparatus 1300C further includes a second plug-in selection control displaying module 1320C configured to display a second plug-in selection control related to a second topic for selecting a plug-in for use in interaction of the second topic, in response to an operation of starting the second topic in the session window.

In some embodiments, the first plug-in selection control related to the first topic is displayed near a split line of the first topic and a previous topic, and the second plug-in selection control related to the second topic is displayed near a split line of the first topic and the second topic.

FIG. 13D illustrates a schematic structural block diagram of an apparatus 1300D for information interaction according to some embodiments of the present disclosure. The apparatus 1300D may be implemented as or be included in the terminal device 110. The various modules/components of the apparatus 1300D may be implemented by hardware, software, firmware or any combination thereof.

The apparatus 1300D includes an interface element presenting module 1310D configured to present, in an interactive window for a first user to interact with a digital assistant, an interface element related to a plug-in in a topic, through which a plug-in used in a corresponding topic can be selected or viewed, and each plug-in is configured to perform a corresponding function. The apparatus 1300D further includes a task performing module 1320D configured to perform, within the interactive window, a task requested by the first user based on the plug-in selected in a current topic during interaction of the first user with the digital assistant in the current topic.

In some embodiments, the interface element presenting module 1310D is further configured to present, in response to an operation of starting a current topic in the interactive window, a first interface element associated with a plug-in in the current topic, the plug-in used in the current topic being selected via the first interface element.

In some embodiments, in the interactive window, a plug-in used in a history topic may be viewed by a second interface element related to the plug-in in the history topic.

In some embodiments, the apparatus 1300D further includes a change disabling module configured to disable a change to the plug-in selected in the current topic, in response to receiving at least one session message in the current topic.

In some embodiments, the interface element related to the plug-in in the topic include at least one of: a plug-in selection panel related to the corresponding topic, the plug-in selection panel including a list of plug-ins; or a plug-in selection control through which a presentation of the plug-in selection panel is triggered.

In some embodiments, a first plug-in selection control of the plug-in selection panel related to the current topic is presented on top in the interactive window.

In some embodiments, the apparatus 1300D further includes the on-top presentation cancel module configured to cancel the ceiling presentation of the first plug-in selection control on top in response to at least a portion of the interaction information related to a history topic being presented in the interactive window.

In some embodiments, a plug-in search function is provided in the plug-in selection panel for searching a plug-in from the list of plug-ins.

In some embodiments, the apparatus 1300D further includes a details panel providing module configured to provide a details panel of a first plug-in in the list of plug-ins in response to a details viewing request for the first plug-in, where the details panel at least includes a description of a function of the first plug-in.

In some embodiments, the interactive window is presented in association with target content, interaction of the first user with the digital assistant in a topic of the interactive window is performed at least in a context of the target content, and where the plug-ins selectable in the topic of the interactive window are determined based on the target content.

In some embodiments, if a new topic is triggered in the interactive window, at least one plug-in is selected by default for the new topic.

In some embodiments, if the at least one plug-in is selected in the corresponding topic, interface element related to the plug-in in the corresponding topic include identification information of one or more of the at least one plug-in.

In some embodiments, the apparatus 1300D further includes a first reply displaying module configured to present a first reply of the digital assistant in the interactive window, where the first reply includes an execution result of the task and identification information of a plug-in used for performing the task.

In some embodiments, the apparatus 1300D further includes a plug-in usage status displaying module, configured to present a plug-in usage status in the interactive window in the process of generating the first reply, where the plug-in usage status indicates the plug-in being used.

It should be understood that one or more steps of the above methods may be performed by a suitable electronic device or a combination of electronic devices. Such electronic devices or combinations of the electronic devices may include, for example, the server 130, the terminal device 110, and/or a combination of the server 130 and the terminal device 110 in FIG. 1.

FIG. 14 illustrates a block diagram of an electronic device 1400 in which one or more embodiments of the present disclosure can be implemented. It should be understood that the electronic device 1400 shown in FIG. 14 is only illustrative and should not constitute any limitation on the functionality and scope of the embodiments described herein. The electronic device 1400 shown in FIG. 14 may be used to implement the terminal device 110 of FIG. 1.

As shown in FIG. 14, the electronic device 1400 is in the form of a general-purpose electronic device. The components of the electronic device 1400 may include, but are not limited to, one or more processors or processing units 1410, a memory 1420, a storage device 1430, one or more communication units 1440, one or more input devices 1450, and one or more output devices 1460. The processing units 1410 may be an actual or virtual processor, and can perform various processes based on the programs stored in the memory 1420. In a multiprocessor system, multiple processing units execute computer executable instructions in parallel to improve the parallel processing capability of the electronic device 1400.

The electronic device 1400 typically include multiple computer storage media. Such media can be any available medium accessible to the electronic device 1400, including but not limited to volatile and non-volatile media, removable and non-removable media. The memory 1420 may be a volatile memory (such as a register, a cache, a random access memory (RAM)), a non-volatile memory (such as a read-only memory (ROM), an electrically erasable programmable read-only memory (EEPROM), a flash memory), or some combination thereof. The storage device 1430 may be a removable or non-removable medium, and may include a machine readable medium such as a flash drive, a disk, or any other medium that can be used to store information and/or data and can be accessed within the electronic device 1400.

The electronic device 1400 may further include additional removable/non-removable, volatile/non-volatile storage media. Although not shown in FIG. 14, disk drivers for reading or writing from removable, non-volatile disks (such as “floppy disks”) and optical disk drivers for reading or writing from removable, non-volatile disks may be provided. In these cases, each driver may be connected to a bus (not shown) by one or more data medium interfaces. The memory 1420 may include a computer program product 1425, which has one or more program modules configured to perform various methods or actions of various embodiments of the present disclosure.

The communication unit 1440 enables communication with other electronic devices through communication media. Additionally, the functionality of the components of the electronic device 1400 may be achieved through a single computing cluster or multiple computing machines, which can communicate through communication connections. Therefore, the electronic device 1400 may operate in a networked environment using logical connections with one or more other servers, network personal computers (PCs), or another network node.

The input devices 1450 may be one or more input devices, such as a mouse, a keyboard, a trackball, and so on. The output devices 1460 may be one or more output devices, such as a presenter, a speaker, a printer, and so on. The electronic device 1400 may also communicate with one or more external devices (such as storage devices, presentation devices, etc.) (not shown) as needed through the communication unit 1440, to communicate with one or more devices that enable users to interact with the electronic device 1400, or to communicate with any device that enables the electronic device 1400 to communicate with one or more other electronic devices (such as network cards, modems, etc.). Such communication may be performed through input/output (I/O) interfaces (not shown).

According to an exemplary implementation of the present disclosure, there is provided a computer-readable storage medium, on which computer-executable instructions are stored, wherein the computer-executable instructions are executed by a processor to implement the method described above. According to the exemplary implementation of the present disclosure, there is also provided a computer program product, which is tangibly stored on a non-transitory computer-readable medium and includes computer-executable instructions, which are executed by a processor to implement the method described above.

Here, various aspects of the present disclosure are described with reference to flowcharts and/or block diagrams of the methods, apparatuses, devices, and computer program products implemented in accordance with the present disclosure. It should be understood that each block in the flowcharts and/or the block diagrams, as well as the combination of each block in the flowcharts and/or the block diagrams, may be implemented by computer-readable program instructions.

These computer-readable program instructions may be provided to a processing unit of a general-purpose computer, special-purpose computer, or other programmable data processing apparatus to produce a machine, such that the instructions, which execute via the processing unit of the computer or other programmable data processing apparatus, create means for implementing the functions/acts specified in the flowchart and/or block diagram block or blocks. These computer-readable program instructions may also be stored in a computer-readable storage medium that can direct a computer, programmable data processing apparatus, and/or other devices to function in a particular manner, such that the computer-readable medium storing the instructions includes an article of manufacture including instructions which implement various aspects of the functions/acts specified in the flowchart and/or block diagram block or blocks.

The computer-readable program instructions may be loaded onto a computer, other programmable data processing apparatus, or other devices, causing a series of operational steps to be performed on a computer, other programmable data processing apparatus, or other devices, to produce a computer implemented process such that the instructions which execute on the computer, other programmable data processing apparatus, or other devices implement the functions/acts specified in the flowchart and/or block diagram block or blocks.

The flowchart and block diagrams in the Figures illustrate the architecture, functionality, and operation of possible implementations of systems, methods and computer program products according to various implementations of the present disclosure. In this regard, each block in the flowchart or block diagrams may represent a module, segment, or portion of an instruction which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having described implementations of the present disclosure above, the foregoing description is exemplary, not exhaustive, and is not limited to the implementations disclosed. Many modifications and variations will be apparent to those of ordinary skill in the art without departing from the scope and spirit of the implementations described. The choice of terms used herein is intended to best explain the principles of the implementations, the practical application, or improvements to technologies in the marketplace, or to enable others of ordinary skill in the art to understand the implementations disclosed herein.

What is claimed is:

1. A method for information interaction, comprising:
in response to an operation of invoking a digital assistant in a first page, displaying a first interactive window for a first user to interact with the digital assistant; and
displaying one or more plug-ins selected by default in the first interactive window,
wherein the one or more plug-ins selected by default have a first association relationship with the first page, and each plug-in is configured to perform a corresponding function.

2. The method of claim 1, further comprising:
in response to an operation of invoking a main session window, displaying the main session window for the first user to interact with the digital assistant,
wherein an application providing the main session window and an application providing the first page are different applications.

3. The method of claim 2, wherein the method further comprises one or more of the following:
displaying a plug-in selection control in the main session window; and
synchronizing an interaction message in the first interactive window to the main session window for the first user to interact with the digital assistant.

4. The method of claim 1, further comprising:
in response to a plug-in selection operation of a user, displaying a plug-in selected by the user in the first interactive window.

5. The method of claim 1, wherein the first association relationship comprises one or more of the following:
an association relationship with a service type of an application providing the first page,
an association relationship with a content presented by the first page,
an association relationship with a selected portion of the content presented by the first page, and
an association relationship between a history topic of the first user and the digital assistant in the first page.

6. The method of claim 1, further comprising:
displaying a first plug-in selection control related to a first topic in a session window for the first user to interact with the digital assistant, for selecting a plug-in for use in interaction of the first topic, in response to an operation of starting the first topic in the session window; and
displaying a second plug-in selection control related to a second topic, for selecting a plug-in for use in interaction of the second topic, in response to an operation of starting the second topic in the session window.

7. The method of claim 6, wherein,
the first plug-in selection control related to the first topic is displayed near a split line of the first topic and a previous topic, and
the second plug-in selection control related to the second topic is displayed near a split line of the first topic and the second topic.

8. The method of claim 1, further comprising:
presenting, in the interactive window for the first user to interact with the digital assistant, an interface element related to a plug-in in a topic, a plug-in used in a corresponding topic being selected or viewed via the interface element, and each plug-in being configured to perform a corresponding function; and
performing, within the interactive window, a task requested by the first user based on the plug-in selected in a current topic during interaction of the first user with the digital assistant in the current topic.

9. The method of claim 8, wherein presenting an interface element related to a plug-in in a topic comprises:
in response to an operation of starting the current topic in the interactive window, presenting a first interface element related to the plug-in in the current topic, the plug-in used in the current topic being selected via the first interface element.

10. The method of claim 8, wherein in the interactive window, a plug-in used in a history topic is viewable through a second interface element related to the plug-in in the history topic.

11. The method of claim 8, further comprising:
disabling a change to the plug-in selected in the current topic in response to receiving at least one session message in the current topic.

12. The method of claim 9, wherein the interface element related to the plug-in in the topic comprise at least one of:
a plug-in selection panel related to a corresponding topic, the plug-in selection panel comprising a list of plug-ins; or
a plug-in selection control through which a presentation of the plug-in selection panel is triggered.

13. The method of claim 12, wherein a first plug-in selection control of the plug-in selection panel related to the current topic is presented on top in the interactive window.

14. The method of claim 13, further comprising:
canceling the on-top presentation of the first plug-in selection control in response to at least a portion of interaction information related to a history topic being presented in the interactive window.

15. The method of claim 12, wherein a plug-in search function is provided in the plug-in selection panel for searching a plug-in from the list of plug-ins.

16. The method of claim 12, further comprising:
providing a details panel of a first plug-in in the list of plug-ins in response to a details viewing request for the first plug-in, the details panel comprising at least a description of a function of the first plug-in.

17. The method of claim 8, wherein the interactive window is presented in association with target content, interaction of the first user with the digital assistant in a topic of the interactive window is performed at least in a context of the target content, and wherein plug-ins selectable in the topic of the interactive window are determined based on the target content.

18. The method of claim 9, further comprising:
presenting a first reply of the digital assistant in the interactive window, wherein the first reply comprises an execution result of the task and identification information of a plug-in used for performing the task; and/or
presenting a plug-in usage status in the interactive window during the generation of the first reply, the plug-in usage status indicating the plug-in being used.

19. An electronic device, comprising:
at least one processing unit;
at least one memory coupled to the at least one processing unit and storing instructions for execution by the at least one processing unit, the instructions, when executed by the at least one processing unit, causing the electronic device to perform actions comprising:
in response to an operation of invoking a digital assistant in a first page, displaying a first interactive window for a first user to interact with the digital assistant; and
displaying one or more plug-ins selected by default in the first interactive window,
wherein the one or more plug-ins selected by default have a first association relationship with the first page, and each plug-in is configured to perform a corresponding function.

20. A computer-readable storage medium having a computer program stored thereon that is executable by a processor to implement actions comprising:
in response to an operation of invoking a digital assistant in a first page, displaying a first interactive window for a first user to interact with the digital assistant; and
displaying one or more plug-ins selected by default in the first interactive window,
wherein the one or more plug-ins selected by default have a first association relationship with the first page, and each plug-in is configured to perform a corresponding function.
